(19) United States
(12) Patent Application Publication
(10) Pub. No.: US 2017/0246541 A1
(43) Pub. Date: Aug. 31, 2017

(54) GAME SYSTEM AND PROGRAM

(71) Applicant: Konami Digital Entertainment Co., Ltd., Tokyo (JP)

(72) Inventors: Ryu SASAKI, Tokyo (JP); Takashi SAKUMA, Tokyo (JP); Satoru EBIHARA, Tokyo (JP)

(73) Assignee: Konami Digital Entertainment Co., Ltd., Tokyo (JP)

(21) Appl. No.: 15/594,725

(22) Filed: May 15, 2017

Related U.S. Application Data
(63) Continuation-in-part of application No. PCT/JP2015/084145, filed on Dec. 4, 2015.

(30) Foreign Application Priority Data
Dec. 12, 2014 (JP) 2014-252473

(51) Int. Cl. A63F 13/00; A63F 13/48

(52) U.S. Cl. CPC A63F 13/67

(57) ABSTRACT

A game system includes a selection device and a game control device. The selection device may be configured to select, for selecting one or more base games, at least one of a) the number of one or more primary games; and b) a type of the one or more base games, using at least a predefined information. A game control device may be configured to start or advance a secondary game, which is subordinate to the one or more primary games, based at least in part on a game state of the one or more base games selected by the selection device.

### TECHNICAL FIELD

Embodiments of the present invention generally relate to a game system and a program.

### BACKGROUND ART

Japanese Patent Application Publication No. 2012-5766 discloses a conventional game machine, wherein a base game (primary game) and a secondary game that advances based on the game situation of the base game are provided. The game machine is designed to provide a pusher game with the object of dropping a playing medium such as medals from a field and a drawing game that advances based on the game situation of the pusher game. The relationship of correspondence between the base game and the secondary game is fixed and it has been sometimes difficult to flexibly accommodate diversity in the methods of playing with the game machine. In the game machine, for example, it has been difficult to accommodate simultaneously both a user who wants to play a game alone and a user who wants to play a game in cooperation with a plurality of people. It also has been easy to satisfy the needs of a user who wants to make a particular desired game, of a number of games, the base game.

### SUMMARY

In some aspects, a game system may include, but is not limited to, a selection device and a game control device. The selection device may be configured to select, for selecting one or more base games, at least one of a) the number of one or more primary games; and b) a type of the one or more base games, using at least a predefined information. A game control device may be configured to start or advance a secondary game, which is subordinate to the one or more primary games, based at least in part on a game state of the one or more base games selected by the selection device.

### BRIEF DESCRIPTION OF THE DRAWINGS

FIG. 1 is a diagram showing an example of the overall configuration of a game machine according to a first embodiment.

FIG. 2 is block diagram of a base game selection according to the same embodiment.

FIG. 3 is a block diagram showing the configuration of a game system according to the same embodiment.

FIG. 4 is an enlarged view of the station unit according to the same embodiment.

FIG. 5 is an enlarged view of the game field according to the same embodiment.

FIG. 6 is a first drawing for describing a slot machine game according to the same embodiment.

FIG. 7 is a second drawing for describing the slot machine game according to the same embodiment.

FIG. 8 is a block diagram showing the general functional configuration of a game machine according to the same embodiment.

FIG. 9 shows one example of setting information according to the same embodiment.

FIG. 10 shows examples of user information according to the same embodiment.

FIG. 11 is a block diagram showing the general functional configuration of a unit managing device according to the same embodiment.

FIG. 12 is a flowchart showing the operation of the game machine according to the same embodiment.

FIG. 13 is a flowchart showing a first example of the flow of selection processing by the game machine according to the same embodiment.

FIG. 14 is a flowchart showing a second example of the flow of selection processing by the game machine according to the same embodiment.

FIG. 15 is a flowchart showing a third example of the flow of selection processing by the game machine according to the same embodiment.

FIG. 16 is a flowchart showing one example of the flow of switching processing by the game machine according to the same embodiment.

FIG. 17 is a first drawing for describing a bingo game according to a second embodiment.

FIG. 18 is a second drawing for describing the bingo game according to the same embodiment.

FIG. 19 is a conceptual drawing of base game selection according to a third embodiment.

FIG. 20 is an oblique view showing a physical drawing mechanism according to the same embodiment.

FIG. 21 is an overall view of a game machine according to a fourth embodiment.

FIG. 22 is a conceptual drawing of base game selection according to the same embodiment.

FIG. 23 is a block diagram showing the general functional configuration of a game machine according to the same embodiment.

FIG. 24 is a block diagram showing the general functional configuration of the unit managing device according to the same embodiment.

FIG. 25 is a conceptual drawing of base game selection according to a modified example.

### DETAILED DESCRIPTIONS

In some aspects, a game system may include, but is not limited to, a selection device and a game control device. The selection device may be configured to select, for selecting one or more base games, at least one of a) the number of one or more primary games; and b) a type of the one or more base games, using at least a predefined information. A game control device may be configured to start or advance a secondary game, which is subordinate to the one or more primary games, based at least in part on a game state of the one or more base games selected by the selection device.

In some cases, the selection device may be configured to acquire a user-relationship information representing relationships among users and select the at least one of a) the number of one or more primary games; and b) the type of the one or more base games, using at least the user-relationship information as the predefined information.

In some cases, the selection device may be configured to acquire a time information and select the at least one of a) the number of one or more primary games; and b) the type of the one or more base games, using at least the time information as the predefined information.

In some cases, the selection device may be configured to acquire a user-operation information and select the at least one of a) the number of one or more primary games; and b) the type of the one or more base games, using at least the user-operation information as the predefined information.

In some cases, the selection device may be configured to acquire a random-number information and select the at least one of a) the number of one or more primary games; and b) the type of the one or more base games, using at least the random-number information as the predefined information.

In some cases, the selection device may be configured to advance the secondary game using a previous advanced state information of the secondary game, in case that the selection device has selected at least one of a different number of the primary games and a different type of the primary games, wherein the previous advanced state being a previous state of having advanced the secondary game before the selection device has selected at least one of the different number and the different type, the different number of the primary games is different from the number of the primary games that the selection device had selected, and the different type is different from the type of the primary games that the selection device had selected.

In some cases, the selection device may be configured to acquire a user-relationship information representing relationships among users and select the at least one of a) the number of one or more primary games; and b) the type of the one or more base games, using at least the user-relationship information as the predefined information. The selection device may be configured to advance the secondary game using a previous advanced state information of the secondary game, in case that the selection device has selected at least one of a different number of the primary games and a different type of the primary games, wherein the previous advanced state being a previous state of having advanced the secondary game before the selection device has selected at least one of the different number and the different type, the different number of the primary games is different from the number of the primary games that the selection device had selected, and the different type is different from the type of the primary games that the selection device had selected.

In some cases, the selection device may be configured to acquire a time information and select the at least one of a) the number of one or more primary games; and b) the type of the one or more base games, using at least the time information as the predefined information. The selection device may be configured to advance the secondary game using a previous advanced state information of the secondary game, in case that the selection device has selected at least one of a different number of the primary games and a different type of the primary games, wherein the previous advanced state being a previous state of having advanced the secondary game before the selection device has selected at least one of the different number and the different type, the different number of the primary games is different from the number of the primary games that the selection device had selected, and the different type is different from the type of the primary games that the selection device had selected.

In some cases, the selection device may be configured to acquire a user-operation information and select the at least one of a) the number of one or more primary games; and b) the type of the one or more base games, using at least the user-operation information as the predefined information. The selection device may be configured to advance the secondary game using a previous advanced state information of the secondary game, in case that the selection device has selected at least one of a different number of the primary games and a different type of the primary games, wherein the previous advanced state being a previous state of having advanced the secondary game before the selection device has selected at least one of the different number and the different type, the different number of the primary games is different from the number of the primary games that the selection device had selected, and the different type is different from the type of the primary games that the selection device had selected.

In some cases, the selection device may be configured to acquire a random-number information and select the at least one of a) the number of one or more primary games; and b) the type of the one or more base games, using at least the random-number information as the predefined information. The selection device may be configured to advance the secondary game using a previous advanced state information of the secondary game, in case that the selection device has selected at least one of a different number of the primary games and a different type of the primary games, wherein the previous advanced state being a previous state of having advanced the secondary game before the selection device has selected at least one of the different number and the different type, the different number of the primary games is different from the number of the primary games that the selection device had selected, and the different type is different from the type of the primary games that the selection device had selected.

In some cases, the game control device is configured to determine whether or not a previous advanced state of the secondary game reaches a predefined game state. The game control device is configured to start or advance the secondary game, after the game control device determined that the previous advanced state of the secondary game reached the predefined game state, in case that the selection device has selected at least one of a different number of the primary games and a different type of the primary games. The previous advanced state being a previous state of having advanced the secondary game before the selection device has selected at least one of the different number and the different type. The different number of the primary games is different from the number of the primary games that the selection device had selected, and the different type is different from the type of the primary games that the selection device had selected.

In some cases, the selection device may be configured to acquire a user-relationship information representing relationships among users and select the at least one of a) the number of one or more primary games; and b) the type of the one or more base games, using at least the user-relationship information as the predefined information. The game control device is configured to determine whether or not a previous advanced state of the secondary game reaches a predefined game state. The game control device is configured to start or advance the secondary game, after the game control device determined that the previous advanced state of the secondary game reached the predefined game state, in case that the selection device has selected at least one of a different number of the primary games and a different type of the primary games. The previous advanced state being a previous state of having advanced the secondary game before the selection device has selected at least one of the different number and the different type. The different number of the primary games is different from the number of the primary games that the selection device had selected, and the different type is different from the type of the primary games that the selection device had selected.

In some cases, the selection device may be configured to acquire a time information and select the at least one of a) the number of one or more primary games; and b) the type of the one or more base games, using at least the time information as the predefined information. The game control device is configured to determine whether or not a previous advanced state of the secondary game reaches a predefined game state. The game control device is configured to start or advance the secondary game, after the game control device determined that the previous advanced state of the secondary game reached the predefined game state, in case that the selection device has selected at least one of a different number of the primary games and a different type of the primary games. The previous advanced state being a previous state of having advanced the secondary game before the selection device has selected at least one of the different number and the different type. The different number of the primary games is different from the number of the primary games that the selection device had selected, and the different type is different from the type of the primary games that the selection device had selected.

In some cases, the selection device may be configured to acquire a user-operation information and select the at least one of a) the number of one or more primary games; and b) the type of the one or more base games, using at least the user-operation information as the predefined information. The game control device is configured to determine whether or not a previous advanced state of the secondary game reaches a predefined game state. The game control device is configured to start or advance the secondary game, after the game control device determined that the previous advanced state of the secondary game reached the predefined game state, in case that the selection device has selected at least one of a different number of the primary games and a different type of the primary games. The previous advanced state being a previous state of having advanced the secondary game before the selection device has selected at least one of the different number and the different type. The different number of the primary games is different from the number of the primary games that the selection device had selected, and the different type is different from the type of the primary games that the selection device had selected.

In some cases, the selection device may be configured to acquire a random-number information and select the at least one of a) the number of one or more primary games; and b) the type of the one or more base games, using at least the random-number information as the predefined information. The game control device is configured to determine whether or not a previous advanced state of the secondary game reaches a predefined game state. The game control device is configured to start or advance the secondary game, after the game control device determined that the previous advanced state of the secondary game reached the predefined game state, in case that the selection device has selected at least one of a different number of the primary games and a different type of the primary games. The previous advanced state being a previous state of having advanced the secondary game before the selection device has selected at least one of the different number and the different type. The different number of the primary games is different from the number of the primary games that the selection device had selected, and the different type is different from the type of the primary games that the selection device had selected.

In some cases, the game control device is configured to determine, in case that the selection device selected plural primary games, whether or not a currently advanced state of each of the plural primary games, selected by the selection device, belonging to the primary games, reaches a respectively predefined game state and the game control device is configured to determine whether or not the number of the plural primary games, which are each determined to have reached the respectively predefined game state, is equal to or more than a threshold. The game control device is configured to start or advance the secondary game, after the game control device determined that the number of the plural primary games is equal to or more than a threshold.

In some cases, the game control device is configured to distribute reward of the secondary game to each of players that are playing the plural primary games selected by the selection device.

In other aspects, a game method may include, but is not limited to, selecting, for selecting one or more base games, at least one of a) the number of one or more primary games; and b) a type of the one or more base games, using at least a predefined information; and starting or advancing a secondary game, which is subordinate to the one or more primary games, based at least in part on a game state of the one or more base games selected.

In other aspects, a non-transitory computer readable medium that stores one or more computer programs, when executed by one or more computers, causing the one or more computers to perform a game method which may include, but is not limited to, selecting, for selecting one or more base games, at least one of a) the number of one or more primary games; and b) a type of the one or more base games, using at least a predefined information; and starting or advancing a secondary game, which is subordinate to the one or more primary games, based at least in part on a game state of the one or more base games selected.

An embodiment of the present invention is described below, with references made to the drawings.

### First Embodiment

(Game System Overview)

The first embodiment of the present invention will now be described.

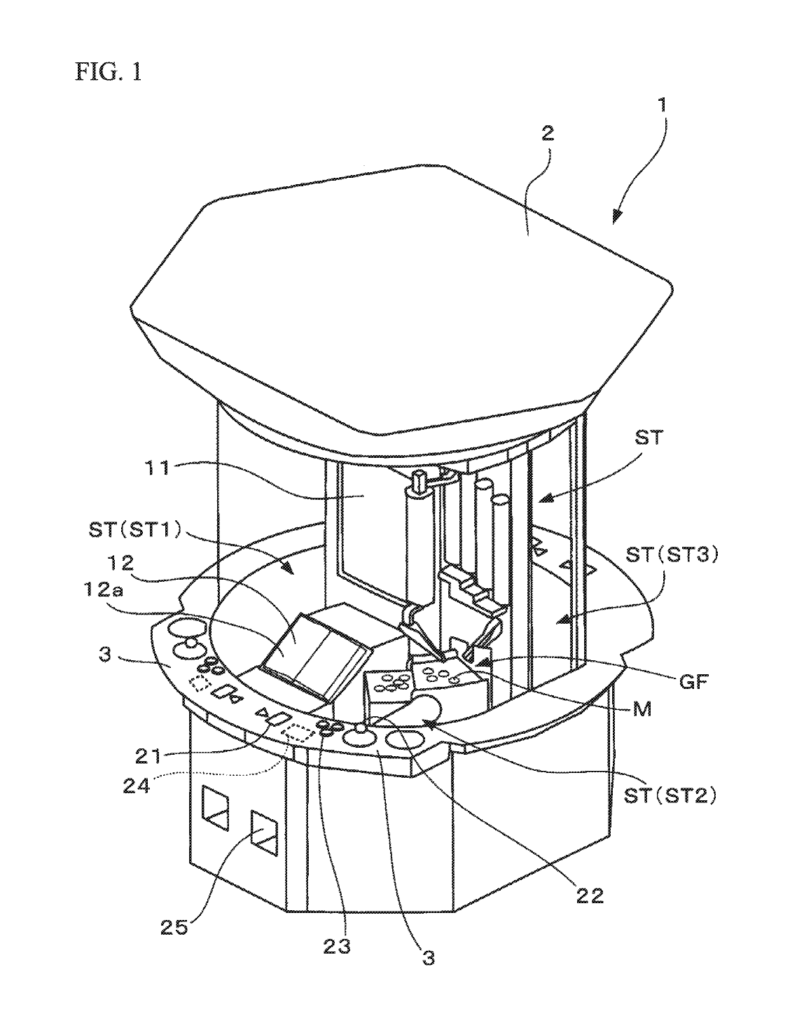

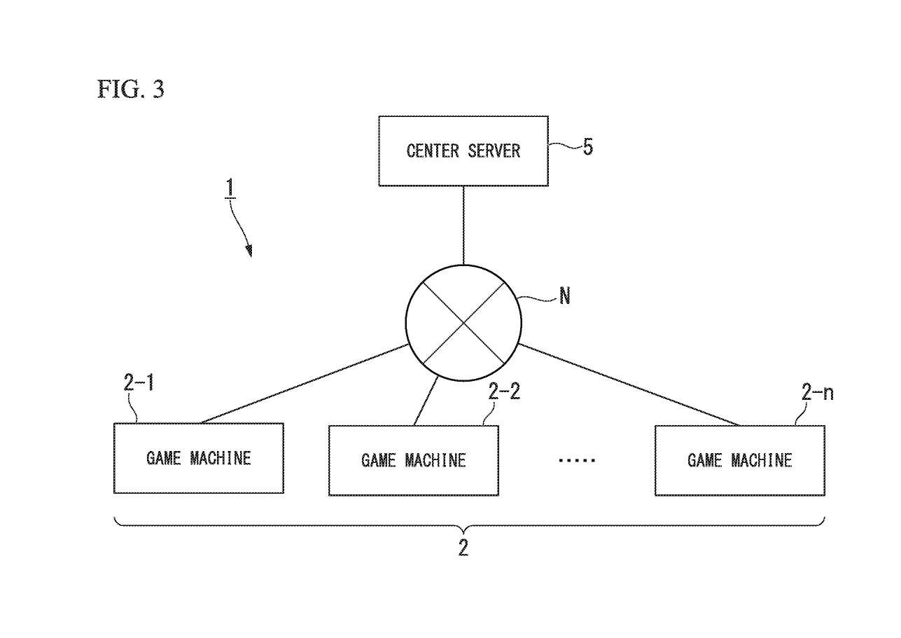

FIG. 1 is an overall view of a game machine 2 provided in the game system 1 according to the present embodiment shown in FIG. 3.

The game machine 2 shown in FIG. 1 is a so-called medal game. The game machine 2 has a plurality of station units ST, and a plurality of base games are executed at the station units ST simultaneously. The game machine 2 can, in addition to the plurality of base games, execute separately or in concert at the plurality of station units ST a secondary game, which advances based on the base game. The game machine 2 can select a plurality of different games in accordance with prescribed information as the base games that affect the secondary game. The game machine 2 causes advancement of the secondary game based on the game situation of the selected base game.

In the present embodiment, as one example, the case in which the base game is a so-called pusher game that uses medals will be described. In the present embodiment, as one example, the case in which the secondary game is a slot machine game will be described. The game situation is the advancement situation occurring in a game in accordance with user operations or the elapse of time. Specifically, the game situation in the base game that causes advancement of the secondary game is, for example, a prescribed achievement in the base game or the satisfying of a prescribed condition such as a prescribed timing.

An overview of base game selection by the game machine 2 will now be described.

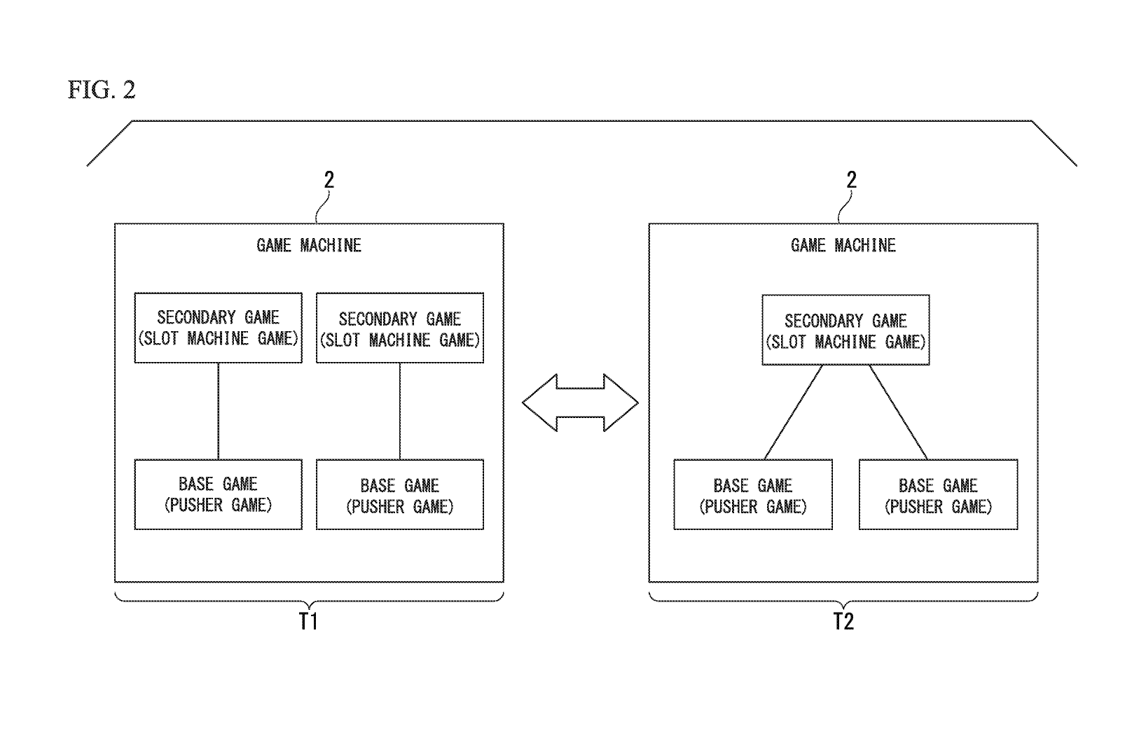

FIG. 2 is a conceptual drawing of base game selection according to the present embodiment.

FIG. 2 shows two states, T1 and T2, as the relationship of correspondence between the base game and the secondary game.

In the state T1, one base game is associated with one secondary game, in which case the secondary game advances based on the game situation in the one base game.

In the state T2, a plurality of base games is associated with one secondary game, in which case the secondary game advances based on the game situations in the two base games. The game machine 2, for example, based on a user operation or a setting of the game machine 2, selects different numbers of base games, thereby, for example, switching between the state T1 and the state T2.

The concept of base game selection will now be described in more detail.

The game machine 2 has two play modes, an individual play mode and a group play mode. In the individual play mode, a pusher game played by one user affects one slot machine game. In the individual play mode, each user can independently enjoy a pusher game and a slot machine game. That is, in the individual play mode, the pusher game and the slot machine game are in the relationship shown by the state T1 in FIG. 2.

In the group play mode, a plurality of pusher games played by a plurality of users affect one slot machine game. That is, in the group play mode, the pusher game and slot machine game are in the relationship shown by the state T2 in FIG. 2. In the group play mode, the users participating in one slot machine game, that is the number of base games, is not limited. For example, the number of base games in the group play mode may be set beforehand, or may be set by a drawing as appropriate. In the following, as an example, the case will be described in which, in the group play mode, the game situation of a pusher game provided in two station units ST (distinction being made by calling the station unit ST on the left side of FIG. 1 the first station unit ST1 and the station unit ST on the right side of FIG. 1 the second station unit ST2) is associated with one slot machine game. In the group play mode, because the game situation of the pusher game that each user plays causes advancement in a common slot machine game, each user can enjoy playing the game with a sense of connection with the others.

The game machine 2, in accordance with, for example, a user operation or a setting of the game machine 2, switches between the individual play mode and the group play mode. When the game machine 2 executes each of the play modes, it selects the pusher game to participate in the group play mode, in accordance with, for example, a user operation or a setting of the game machine 2. In this manner, the game machine 2 can switch between the individual play mode, in which there is one slot machine game base game, and the group play mode, in which there are two base games. The game machine 2 can also switch only the combination of base games (station units ST) without changing the number of base games associated with one slot machine game. Specifically, it may switch from a slot machine game that makes the pusher game of the first station unit ST1 and the pusher game of the second station unit ST2 the base game to a slot machine game that makes the pusher game of the first station unit ST1 and pusher game of the third station unit ST3 the base game. In this manner, the game machine 2 can provide diverse methods of playing.

(Game Station Configuration)

FIG. 3 is a block diagram showing the configuration of the game system 1 according to the present embodiment.

The game system 1 has one or more of the above-described game machines 2-1, 2-2, . . . , 2-n and a center server 5. The game machines 2-1, 2-2, . . . , 2-n and the center server 5 are each connected to a network N, and can mutually communicate. In the following description, the game machines 2-1, 2-2, . . . , 2-n will be collectively referred to as the game machine 2.

The center server 5 is an apparatus that manages play data and user data of each game in the game machine 2.

The network N is an information communication network constituted by a WAN (wide area network) or a LAN (local area network) or the like. A WAN, for example, is constituted by the Internet, a mobile telephone network, a PHS (Personal Handy-phone System) network, a PSTN (public switched telephone network), a dedicated communication circuit network, a VPN (virtual private network), or the like.

(Game Machine Configuration)

Next, the configuration of the game machine 2 will be described.

The game machine 2 is provided with a plurality of station units ST. In the form shown in FIG. 1, four station units ST are provided in the game machine 2, and a first monitor 11 and a second monitor 12 that are used in common by two station units ST are provided between two neighboring station units ST. The first monitor 11 is a liquid crystal display device, on which a bingo game or roulette game or the like is displayed. The second monitor 12 is provided with a book-type screen 12a and with a projector (not shown) that displays a game image on the screen 12a, displaying a slot machine game, which advances based on the game situation in a pusher game, and a roulette game. Parts may be omitted from the game machine 2 shown in FIG. 1 as appropriate.

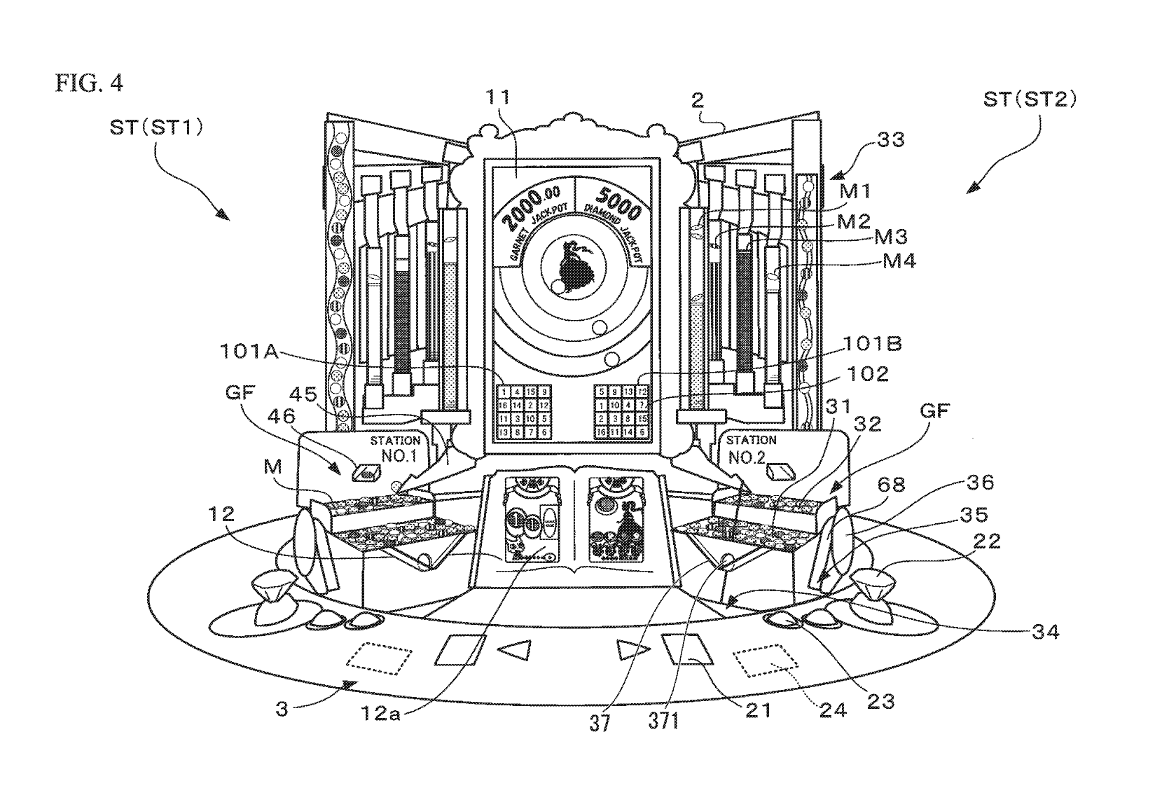

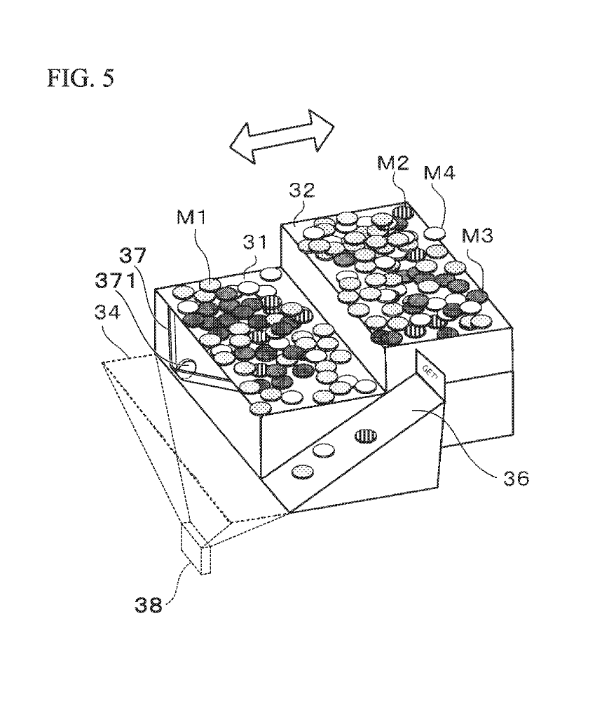

FIG. 4 is an enlarged view of the station unit ST, and FIG. 5 is an enlarged view of the game field GF.

Each station unit ST is constituted to accommodate one user. Because the game field GF faces in the same direction as the station units ST that share and use the monitor 11 and 12 in common, the users playing these station units ST can play the game while verifying the advancement in their own games. The station unit ST executes a pusher game and a slot machine game that advances based on the game situation of the pusher game. Each station unit ST has an operation device 3 whereby a user operates a game, and a game field GF where a game advances in accordance with operations by the user, and the game advances using the physical movement of medals M inserted onto the game field GF. Medals M inserted onto the game field GF internally circulate in the game machine 2 and have different specifications from the medals in that a user inserts or that are paid out to the user (which are sometimes called playing medals).

The operation device 3 of the station unit ST is provided with a medal insertion port 21 for inserting playing medals into the game machine 2, an insertion operating lever 22 for inserting medals M onto the game field GF, operating buttons 23 for making various operations, a card reader 24 for reading a user card 4, and a medal payout port 25 (refer to FIG. 1) for paying out playing medals to the user in response to a game result of the game field GF. Playing medals that have been inserted into the medal insertion port 21 are detected by a medal-detecting sensor (not shown) and are stored as credits in the storage 73. By operating the insertion operating lever 22, a user can insert medals M onto the game field GF to the extent of the credits held.

The game field GF refers to the space in which the game using the medals M advances, this space including a table 31, a pusher table 32, a falling part 34, and a recoverer 35. The station unit ST is provided with a table 31 on which the medals M are placed, a pusher table 32 that moves reciprocally in the front-rear direction along the upper surface of the table 31, a medal supplying mechanism 33 that supplies medals M to the top of the pusher table 32, a drop chute 34 positioned as the front edge of the table 31, onto which the medals M drop, recoverers 35 that recovers the medals M on both sides of the table 31, a parent drop adjusting mechanism 36 provided at the recoverers 35 that adjust the parent drop of the medals M, a checker 37 extending from the front edge of the table 31 and that detects medals M that drop from the center of the front edge of the table 31, and an IC card reader 38 that detects medals M that have dropped into the drop chute 34. The table 31 is fixed to the game field GF. The pusher table 32 moves reciprocally in the direction of the arrows shown, in accordance with operation of a drive mechanism (not shown). The medals M on the top of the pusher table 32 and medals M on top of the table 31 are pushed out and moved by this reciprocal movement. The pushed out medals M move either to the drop chute 34 or to a recoverer 35. Of the medals M, medals M that are pushed out from the center front edge of the table 31 pass through the hole 371 of the checker 37 and move to the drop chute 34. The checker 37 has, for example, an opto-electrical sensor or a magnetic sensor that detects the passing of a medal M through the hole 371. Information of a medal M that has dropped to the drop chute 34 is read by the IC reader 38 and affects the game situation in various games.

Medals M are made of resin and have an IC chip (not shown) into which is recorded identification information. A plurality of attributes are provided in the medals M. Examples of medals supplied to the top of the game field GF by an operation of the inserting operation lever 22 are a blue medal M1 in which a one-credit value is set, a green medal M2 in which a two-credit value is set, a red medal M3 in which a three-credit value is set, and bingo game medals M4 that are linked to each of a plurality of squares on the bingo sheet 101 of a bingo game. If a blue medal M1 drops into the drop chute 34, one credit is granted to the user, and if the green medal M2 or red medal M3 drop into the drop chute 34, two or three credits, respectively, are granted to the user. Each of the colored medals M1 to M3 is formed of light-transmitting resin of the respective colors. The IC chip of each of the color medals M1 to M3 has recorded therein the identification information of each of the colors. The bingo medal M4 is formed of light-transmitting yellow resin. Light-transmitting resin includes transparent resin or semi-transparent resin, and it is sufficient that the resin has the property of passing light.

(Pusher Game)

Playing of a pusher game on the above-described game field GF will now be described.

In playing the pusher game, when the user first inserts a playing medal into the medal insertion port 21, credit is counted in accordance with the playing medal, this being recorded in the storage 73. Next, when the user operates the insertion operating lever 22, a blue medal M1 is supplied to the top of the game field GF via a medal insertion guide 45. When this occurs, when the user operates the operation device 3, the direction of insertion of the medal insertion guide 45 changes. In this case, medals M1 to M4 are in mutual contact with each other, filling the top of table 31 of the game field GF and the pusher table 32. When a medal M1 is inserted, the pushing out force by the reciprocal movement of the pusher table 32 is propagated to the medals M that fill up from the front edge of the pusher table 32 to the front edge of the table 31. A medal M positioned at the front edge of the table 31 is pushed out and drops into the drop chute 34. Alternatively, a medal M positioned at the side of the table 31 is pushed out and drops into a recoverer 35.

The identification information of a medal M that has dropped into the drop chute 34 is read by the IC reader 38. Then, in accordance with the read identification information, various processing is performed, such as for granting of credits, payout of playing medals from the medal payout port 25, advancement processing in a bingo game, and execution of a roulette drawing. A medal M at the center part of the front edge of the table 31 drops through the hole 371 of the checker 37. When the checker 37 detects the dropping of a medal M, the game machine 2 increases the number of reserved drawings by the slot machine game. In this manner, in the pusher game, by causing a medal M to drop into the drop chute 34, the user obtains a reward of a credit, or reserved drawings in the slot machine game.

(Slot Machine Game Individual Play Mode)

The slot machine game will now be described.

In the slot machine game according to the present embodiment, the game advances in different ways, depending upon the play mode. First, the slot machine game in the individual play mode will be described.

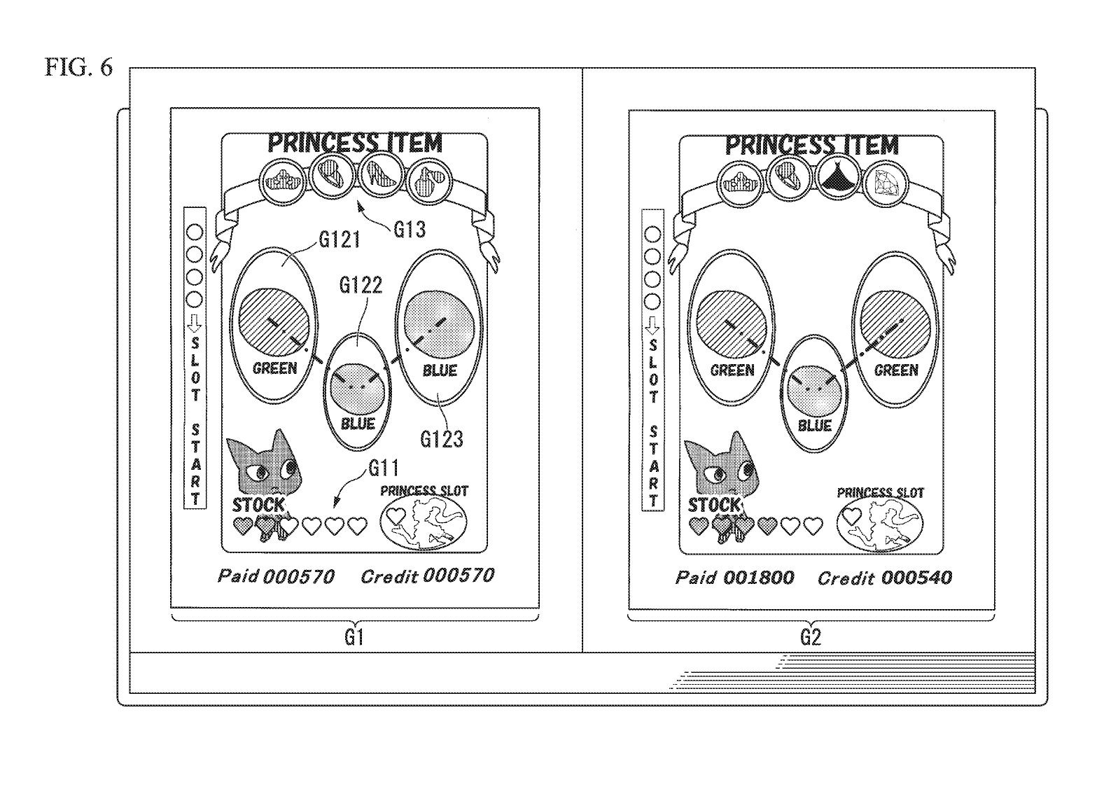

FIG. 6 is for describing a slot machine game in the individual play mode.

In the example shown in FIG. 6, the second monitor 12 displays the game screens G1 and G2 of two slot machine games. Specifically, a game screen G1 of a slot machine game associated with the pusher game of the first station unit ST1 is displayed on the left side of the second monitor 12, and a game screen G2 of a slot machine game associated with the pusher game of the second station unit ST2 is displayed on the right side of the second monitor 12.

The slot machine game according to the present embodiment is a one-line slot machine game in which a determination is made as to whether or not three of the same pictures appear in a single line L1 in the left-right direction. The drawing probability in the slot machine game changes depending upon the type of picture, and the lower the probability of the pictures being aligned, the higher is set the reward. A specific description will now be made of the slot machine game of the first station unit ST1 side. Because the slot machine game on the second station unit ST2 side is the same as the slot machine game on the first station unit ST1 side, its description will be omitted. The number of slot machine game reserved drawings, that is, the number of remaining slot machine games, is shown by the slot machine game lamps G11 at the bottom part of the game screen. One of the slot machine game lamps G11 lights each time a medal M passes through the checker 37 in the associated pusher game. In the slot machine game, one execution is made in exchange for the consumption of a prescribed unit of reserved drawings. The slot machine game lamps G11 are extinguished commensurate with the number of consumed reserved drawings.

Three picture display locations (G121, G122, and G123) are provided so as to be substantially arranged in a V-shaped line L1 in the left-right direction in the center part of the game screen G1. When the slot machine game starts, the pictures to be displayed in each of the picture display locations G121, G122, and G123 are drawn in accordance with pre-established probabilities. The pictures to be displayed in each of the picture display locations G121, G122, and G123 are selected from a plurality of pre-established pictures. At least a part of this plurality of pictures may be associated with colors of the medals M. When the same picture is displayed in all three picture display locations G121, G122, and G123 a win occurs, and a reward having a value in accordance with that type of picture is granted to the user. For example, if the arrangement is of blue pictures, because the blue medal M1 wins, a prescribed number of blue medals M1 are inserted onto the game field GF as a reward. Or, for example, the user is granted a credit of an amount corresponding to the product of the credit value per one blue medal M1 (one credit in this example) and the number of medals won.

An item display location G13 is provided at the top part of the game screen G1. A plurality of types of items are displayed in the item display location G13. If, for example, a specific picture is arranged in the picture display locations G121, G122, and G123 so that a prescribed item granting condition is satisfied, one of the items displayed in the item display location G13 is granted to the user of the first station unit ST1.

In this manner, in the individual play mode, the game machine 2 provides independent slot machine games to the user playing a pusher game at the first station unit ST1 and to the user playing a pusher game at the second station unit ST2.

(Slot Machine Game Group Play Mode)

Next, the slot machine game in the group play mode will be described.

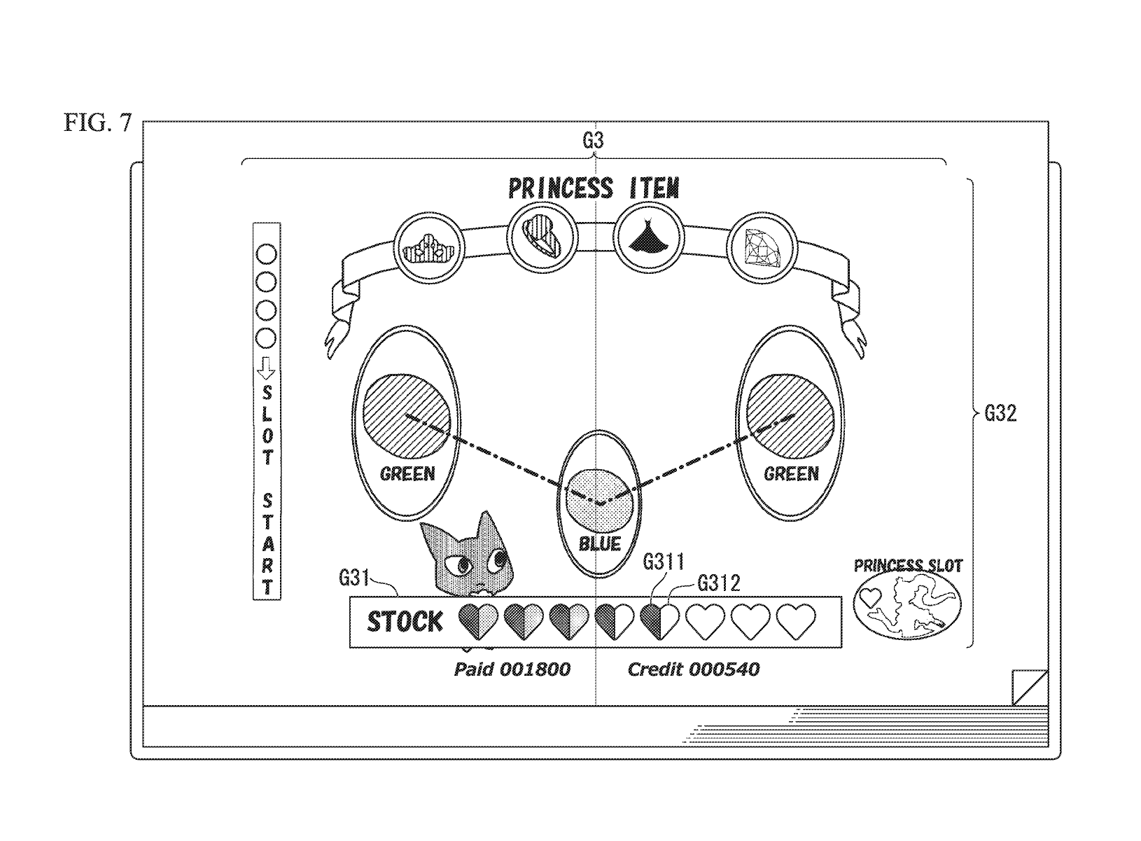

FIG. 7 is for describing a slot machine game in the group play mode.

In the example shown in FIG. 7, the game screen G3 of one slot machine game is displayed on the second monitor 12. The game screen G3 is shared between the first station unit ST1 and the second station unit ST2 and advances based on the game situation in the pusher games at both the station units ST1 and ST2.

Similar to the slot machine game lamps G11 described above for the individual play mode, slot machine game lamps G31 indicating the number of reserved drawings are provided in the bottom part of the game screen G3. Each of the slot machine game lamps G31 is divided between left and right. The divided halves of the slot machine game lamps G31 are allocated to the first station unit ST1 and the second station unit ST2, respectively. Specifically, when a medal M passes through the checker 37 at the first station unit ST1, the left half G311 of a slot machine game lamp G31 lights, and when a medal M passes through the check 37 at the second station unit ST2, the right half G312 of a slot machine game lamp G31 lights. The slot machine game lamp G31 that are lighted on both sides indicate the number of reserved drawings. In the slot machine game, one execution is made in exchange for the consumption of a prescribed unit of reserved drawings. The slot machine game lamps G31 are extinguished commensurate with the number of consumed reserved drawings. In the group play mode, if a prescribed condition is satisfied at both the station unit ST1 and ST2 (if an ANDed condition is satisfied), the slot machine game advances.

The association between the game situations at each station unit in the group play mode and the slot machine game is not restricted to being as described above. Specifically, the slot machine game lamps G31 may be lighted when a medal M passes through the checker 37 at either of the first or second station unit ST1 and ST2 (if an ORed condition is satisfied).

The slot machine game according to the present embodiment has two game modes, the normal mode and the special mode (bonus mode). The normal game mode and the special game mode differ in the amount of consumed reserved drawings and the expected value of a drawing in the slot machine game. Specifically, in the normal mode, although the consumption of reserved drawings is small, the expected drawing value is small. Conversely, in the special mode, although the consumption of reserved drawings is large, the expected drawing value is high. The transition from the normal mode to the special mode is made, for example, when a prescribed condition is satisfied, such as the number of reserved drawings reaching or exceeding a pre-established number.

(Game Machine Control System Configuration)

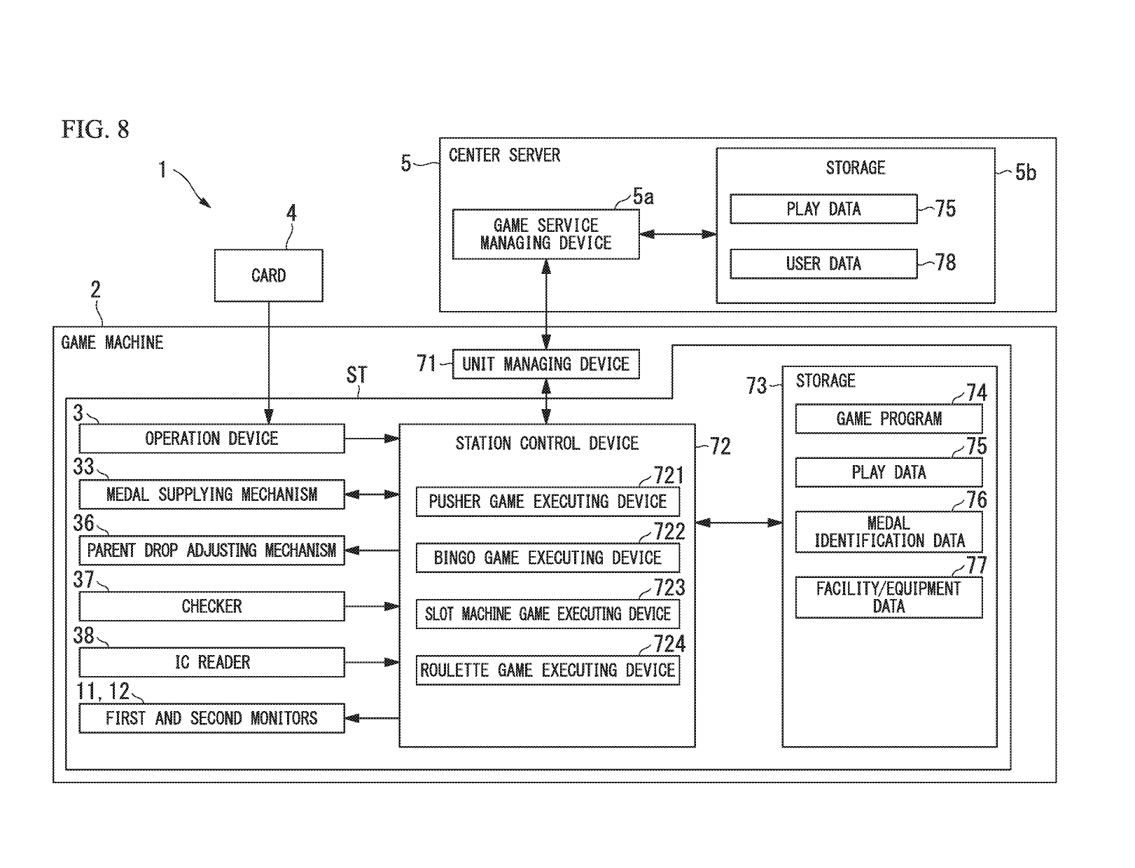

FIG. 8 is a block diagram showing the general configuration of the game machine 2 according to the present embodiment.

In the game machine 2, a unit managing device 71 is provided, which manages the operation of each of the station units ST. The unit managing device 71 adjusts the operation of the first monitor 11 and the second monitor 12 that are used in common between the station units ST, and of the medal supplying mechanism 33. Each of the station units ST is provided with a station control device 72 and a storage 73. The unit managing device 71 and the station control device 72 are logical devices that are implemented by the combination of game machine 2 hardware (including a CPU and memory as the internal storage device thereof) and software. The station control device 72 is connected to an operation device 3 that accepts operations from a user, a medal supplying mechanism 33, a parent drop adjusting mechanism 35, an IC reader 38, a first monitor 11 and second monitor 12, a unit managing device 71, and the like, and requests or acquires signals and data required for the advancement of a game for each of the station units ST. The station control device 72 controls the commonality or separation of the slot machine games, based on unit control information acquired from the unit managing device 71. The station control device 72 is also connected to various sensors, mechanisms, and members necessary for game execution and settings, and controls sending and receiving of signals and data and operation.

The storage 73 is a device that includes a non-volatile storage medium such as a magnetic storage medium, an optical storage medium, or an EEPROM. The storage 73 stores a game program 74 for execution of a game by the game machine 2, play data 75, medal identification data 76 recorded with association between medal M attributes and identification information, and facility/equipment data 77 indicating the facility in which the game machine 2 is installed and setting information for each game machine 2. The storage 73 also stores various data necessary for the execution of a game. The play data 75 is data into which is saved the content of game play for the purpose of a player continuing with the play of a game from midway. The play data 75 has recorded therein data regarding game details such as the results of various games played by the player and regarding items and the like acquired by the player.

By the station control device 72 reading and executing the game program 74 stored in the storage 73, the station control device 72 has, as internal logical devices, a pusher game executing device 721, a bingo game executing device 722, a slot machine game executing device 723, and a roulette game executing device 724. The pusher game executing device 721 executes various processing required in the advancement of the pusher game. For example, it executes processing for insertion of medals M to the game field GF in response to a user operation, the granting of a reward in accordance with the medals M that have dropped into the drop chute 34, the supply of medals M from the medal supplying mechanism 33, and the game presentation by illumination light and the like of the LED units 56, 57a, and 59, in accordance with the game result. The bingo game executing device 722 executes various processing required in the advancement of the bingo game. For example, it executes processing for generation of a bingo sheet 101, advancement of the bingo game in accordance with bingo medals M4 that have dropped into the drop chute 34, game presentation in accordance with the game result, and various drawing processing for the roulette game and jackpot game and the like.

The slot machine game executing device 723 executes various processing required to have a user play the slot machine game in the various modes described above. The roulette game executing device 724 executes various processing required for advancement of a roulette game. The unit managing device 71, for example, executes processing of a game in accordance with operation of operating buttons 23 and processing to switch the game mode of the slot machine game in accordance with the game situation in the pusher game. Although FIG. 8 shows one station unit ST, a plurality of station units ST having the same configuration are actually provided in the game machine 2.

(Center Server Configuration)

The configuration of the center server 5 will now be described.

The center server 5 is constituted as one logical server device by combining a plurality of server units. The center server 5 may, however, be constituted by a single server unit. Alternatively, the center server 5 may be logically constituted using cloud computing. The center server 5 is provided with a game service managing device 5a and a storage 5b.

The game service managing device 5a is a logical device that is implemented by the combination of computer hardware of the center server 5 (including a CPU and memory as the internal storage device thereof necessary for the operation thereof) and software. The storage 5b is an external storage device implemented by a storage unit such as a hard disk array. The storage 5b may be constituted so as to hold all data in a single storage unit, or may be constituted so as to store data distributed in a plurality of storage units. The storage 5b stores various data and, in FIG. 8, is shown to be storing the play data 75 and the user data 78. The user data 78 indicates user information, which is attributes for each user. The play data 75 and the user data 78 are created for each user and stored in the storage 5b in association with the identification information of users. In the example of FIG. 8, as an example, only the play data 75 and the user data 78 are shown, in association with identification information of a single user.

The game service managing device 5a provides a prescribed game service to the game machine 2. Specifically, for example, the game service managing device 5a manages the play data 75 of a user who plays the game machine 2. In this case, the game service managing device 5a first acquires user authentication information (for example, a unique identification number and password for each user) from the game machine 2 and authenticates the user. Next, the game service managing device 5a acquires from the game machine 2 and stores into the storage 5b the play data 75 for that user. Then, for example, if the same user has played the game machine 2 on a different occasion, the game service managing device 5a provides the game machine 2 with the play data 75 of the user stored in its own storage 5b. For example, the game service managing device 5a also provides a service such as updating the software (game programs or data) of the game machine 2 via a network. The user play data 75 is tied to the user identification information stored in the card 4 that the user has.

(Setting Information Examples)

Specific examples of setting information and user information will now be described.

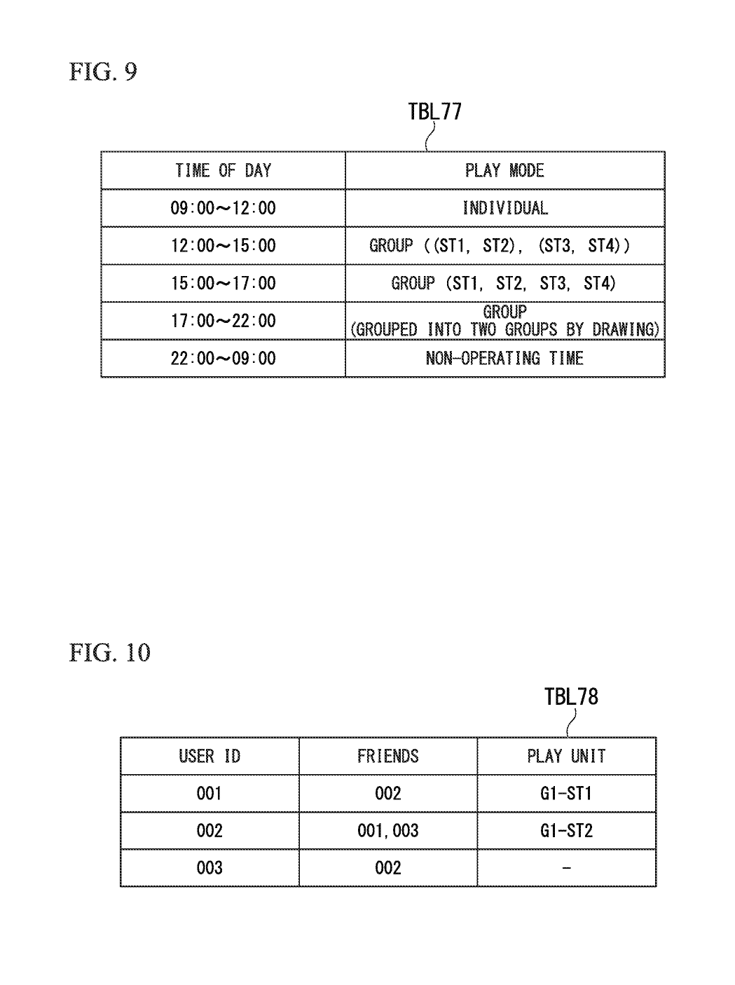

FIG. 9 shows an example of setting information according to the present embodiment.

The setting information according to the present embodiment includes time of the day information (time of the day) and unit information (unit). The setting information is constituted by these two types of information, in association with each other, in a setting information table TBL77. The time of day information is information indicating the time during one day. The unit information is information indicating the slot machine game play mode in the game machine 2. In the present embodiment, because the relationship of correspondence between the pusher game, which is the base game, and the slot machine game, which is the secondary game, changes depending upon the play mode, the unit information is an example of information representing the base game.

Types of unit information are, for example, “individual” and “group.” If “individual” is set, an individual-play mode slot machine game is executed. That is, one slot machine game is executed at each station unit ST, and the slot machine game at each station unit ST advances based on the game situation in the pusher game.

In contrast, if “group” is set, a group-play mode slot machine game is executed in each station unit ST set in a combination. In the case of “group,” the selection of a combination of station units ST by drawing may be coded in the setting information, and a setting may be made so as to always select a combination in the case of “group.” The unit managing device 71 selects the relationship of correspondence between the slot machine game and the pusher game for each time of the day, based on the relationship of correspondence between the time of day and the unit information.

(Examples of User Information)

FIG. 10 shows examples of user information according to the present embodiment.

The user information according to the present embodiment includes user identification information (user ID), relationship type information (friending), and play unit information (play unit). The user information is constituted with these types of information associated in a user information table TBL78. The relationship type information indicates another user in a prescribed relationship with a user. In this case, the prescribed relationship type is, for example, being a friend or lover. As an example, the prescribed relationship type will be described for the case of a friend relationship. The value of the friend information is represented by the user identification information of that friend.

The play unit information indicates the station unit ST that the user plays. The play unit information, for example, is represented as a combination of identification information of a game machine 2 and identification information of a station unit ST. If a user is not playing a game, information is not coded into the play unit information. The unit managing device 71, by searching the user information with the user identification information as the main key, can identify the friends of each user.

The unit managing device 71 by searching the user information again, using the user identification information of a specific friend as a main key, can identify the station unit ST at which a friend is playing. The play unit information is not absolutely necessary, and it is sufficient to use relationship type information indicating whether users playing at each station unit ST have a friend relationship.

(Unit Managing Device Configuration)

The configuration of the unit managing device 71 will now be described.

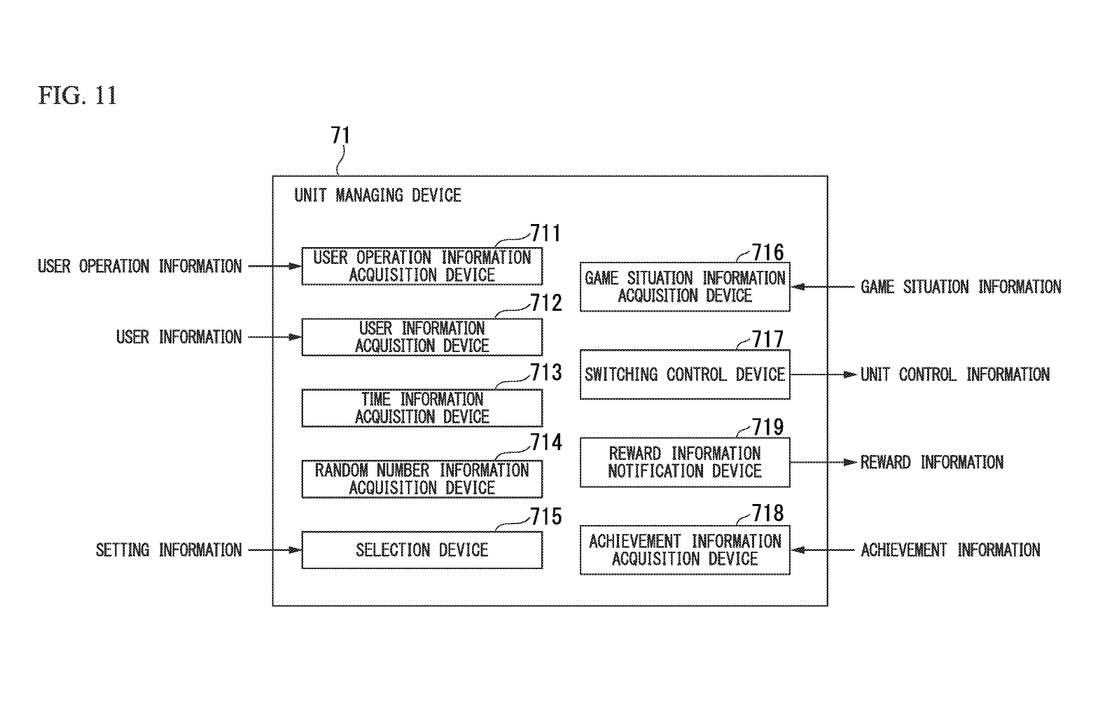

FIG. 11 is block diagram showing the general functional configuration of the unit managing device 71 according to the present embodiment.

The unit managing device 71 controls the relationship of correspondence between the pusher game and the slot machine game provided in each station unit ST of the game machine 2. The unit managing device 71 has a user operation information acquisition device 711, a user information acquisition device 712, a time information acquisition device 713, a random number information acquisition device 714, a selection device 715, a game situation information acquisition device 716, a switching control device 717, an achievement information acquisition device 718, and a reward information notification device 719.

The user operation information acquisition device 711 acquires user operation information indicating an operation by a user that has been accepted by the operating buttons 23 of the operation device 3. The user operation information, for example, indicates the play mode specified by the user. The user operation information may include, for example, another user in a group specified by the user in the group play mode. The specification of the play mode or the like by the user may be made at the start of the game, or may be made as the game advances. The user operation information acquisition device 711 outputs the acquired user operation information to the selection device 715.

The user information acquisition device 712 acquires user information from the center server 5. The user information acquisition device 712 outputs the acquired user information to the selection device 715.

The time information acquisition device 713 acquires from a timekeeper (not shown) time information indicating the current date and time. The time information acquisition device 713 outputs the acquired time information to the selection device 715.

The random number information acquisition device 714 generates a random number based on, for example, the current date and time. The random number information acquisition device 714 outputs the generated random number information to the selection device 715.

The selection device 715 selects the base game of the slot machine game, based on the various information acquired by the user operation information acquisition device 711, the user information acquisition device 712, the time information acquisition device 713, and the random number information acquisition device 714. In the case of the individual play mode, the correspondence relationship between the slot machine game and the base game is established beforehand for each of the station units ST. In the group play mode, the selection device 715 selects the base game of the slot machine game based on prescribed information (user operation information, user information, time information, random number information, and setting information).

The selection device 715 requests the users that will participate in a slot machine game in the group play mode to approve the execution of a slot machine game by the group play mode, for example, by a display via the second monitor 12. If the operation device 3 accepts approval by a user, the selection device 715 makes the pusher game to be played by the user who gave approval the base game of the slot machine game. The selection device 715 outputs to the switching control device 717 correspondence relationship information indicating the relationship of correspondence between the selected slot machine game and pusher game.

The processing by the selection device 715 to select the base game will now be described.

The selection device 715 according to the present embodiment selects the slot machine game play mode based on the following three conditions (1) to (3).

(1) Selection Based on a User Operation

If the operation device 3 of each of the station units ST accepts an operation from a user specifying the individual play mode or the group play mode, the selection device 715 selects the specified play mode. If the group play mode is specified, the operation device 3 may accept an operation that selects another user in the group. In this case, the selection device 715 makes the pusher game to be played by the user that made the play mode specification and the pusher game to be played by the other user specified by the user the base games of one slot machine game. Rather than accepting a selection operation of the other group user, the selection device 715 may automatically set the pusher games to be played by two or more users specifying the group play mode as the base game of one slot machine game.

(2) Selection Based on the Relationship Type between Users

In the game machine 2, if users who are currently playing a pusher game are friends, the selection device 715 makes the pusher games played by each of the users the base game of a common slot machine game. In this case, if a plurality of users who are friends are playing a pusher game, the selection device 715 provides a group play mode slot machine game. In contrast, if the players who are playing are not friends, the selection device 715 provides an individual play mode slot machine game.

The determination of the friend relationship will now be described. First, the selection device 715, based on the user identification information read by the card reader 24 of the operation device 3, acquires the user information of a user who is playing (hereinafter called a first user) from the center server 5. Next, the selection device 715 references the acquired user information and identifies another user (hereinafter called the second user) who is a friend relationship. Next, the selection device 715, based on the user identification information of the second user, acquires the user information of the second user from the center server 5. Next, the selection device 715 references the user information of the second user and determines whether or not, at some station unit ST, the second user is currently playing a pusher game. By doing this, the selection device 715 determines whether or not a plurality of users who have a friend relationship are currently playing a pusher game and makes the pusher games being played by the plurality of users who are in a friend relationship the base game of one slot machine game. The user identification information used in acquiring the user information may be, for example, information input by the user via the operating buttons 23 of the operation device 3. The selection device 715 may acquire user information of each station unit ST from the server 5 based on the user identification information read from each of the card readers 24 of each station unit ST, and may determines whether or not users of two or more station units ST are in a friend relationship, based on their user information.

The users with respect to which a determination is made of a friend relationship may be specified by the user. Specifically, for example, if a user indicates the station unit ST that the user will play in a group, the selection device 715 determines whether or not a user of that station unit ST is in a friend relationship.

In this case, the user information acquisition device 712 acquires user information, based on one of the user identification information read by the card readers 24 of the determination target station unit ST. Next, the selection device 715 references the acquired user information and determines whether or not users of the determination target station unit ST are in a friend relationship. If users of the determination target station unit ST are in a friend relationship, the game machine 2 provides the users a group play mode slot machine game. In this manner, the selection device 715 may select the base game of the slot machine game based both on a user operation and on the relationship between the users.

(3) Selection Based on Facility or Equipment Settings

If the play mode is established beforehand by a setting in the facility (shop) in which the game machine 2 is installed or by a setting by the manufacturer of the game machine 2, the selection device 715 makes the pusher game established by that setting the base game of the slot machine game. Specifically, the selection device 715 references the facility/equipment data 77 stored in the storage 73 and acquires the setting information. The selection device 715 also acquires time information from the time information acquisition device 713. Next, the selection device 715 identifies the setting of the slot machine game corresponding to the current date and time indicated by the acquired time information, based on the setting information. If the individual play mode is set in the setting information, the selection device 715 makes the pusher game for each station unit the base game of the slot machine game at the same station unit ST.

If the group play mode and a combination of pusher games are set in the setting information, the selection device 715 makes the set combination of pusher games the base games of one slot machine game. In the group play mode, if the selection of the combination of the pusher games is set to be made by a drawing, the selection device 715 acquires, for example, two random number values from the random number information acquisition device 714. The selection device 715 makes the pusher games executed in the station units ST corresponding to the two acquired random number values the base game of one slot machine game. Information that associates the random number values with the station units ST is stored, for example, in the storage 73 beforehand. Random numbers may be associated with the combination of two or more station units ST beforehand (for example, the combination of the first station unit ST1 and the second station unit ST2 being associated with a random number value 1 and the combination of the first station unit ST1 and the third station unit ST3 being associated with a random number value 2) and the selection device 715 may establish the combination of pusher games to be associated as the base game for one slot machine game by acquiring one random number value from the random number information acquisition device 714.

Continuing with the description of the unit managing device 71, the game situation information acquisition device 716 references the play data 75 stored in the storage 73 and acquires information indicating the game situation of the pusher game and the game situation of the slot machine game. The game situation information acquisition device 716 outputs the acquired game situation information to the switching control device 717.

The switching control device 717 controls the switching of the base game that affects the slot machine game by outputting to each station unit ST unit control information that controls the operation of various parts in the station units ST. The processing by the switching control device 717 to switch the base game will now be described. First, the switching control device 717 acquires the correspondence relationship information from the selection device 715 and acquires game situation information indicating the game situation of the slot machine game from the game situation information acquisition device 716. Next, the switching control device 717 prepares to switch the play mode of the slot machine game.

Specifically, the switching control device 717 causes the base game pusher game to be switched to advance and holds information indicating the situation in that game. Next, the switching control device 717 advances the slot machine game, based on the game situation of the slot machine game at the starting point in time prepared for switching, as indicated by the game situation information that has been acquired. Next, the switching control device 717 determines whether or not the slot machine game is in a prescribed state. In this case, the prescribed state is, for example, the state in which the number of reserved drawings in the slot machine game has reached zero and the slot machine game drawing has been initialized. If the slot machine game is in the prescribed state, the switching control device 717 controls each station unit ST so that the slot machine game is started with the relationship of correspondence indicated by the correspondence relationship information acquired from the selection device 715. When this is done, the switching control device 717 may start the slot machine game after switching, reflecting the game situation of the pusher game during the preparation for switching and the game situation of the slot machine game before switching. If the play mode is the group play mode, the switching control device 717 controls each the station unit ST so that the game situation of the pusher game that advances at the station unit ST indicated by the correspondence relationship information is reflected in the advance of the slot machine game in the group play mode. When the switching of the correspondence between the slot machine game and the base game is completed, the switching control device 717 outputs the correspondence relationship information acquired from the selection device 715 to the reward information notification device 719.

The achievement information acquisition device 718 at all times acquires from the slot machine game executing device 723 achievement information indicating the achievement in the slot machine game. This achievement information includes identification information of a slot machine game in which an achievement satisfying a prescribed condition has been reached. The achievement information acquisition device 718 outputs the acquired achievement information to the reward information notification device 719.

The reward information notification device 719 grants a reward to a user based on the achievement reached in the slot machine game. Specifically, the reward information notification device 719 acquires achievement information from the achievement information acquisition device 718. Next, the reward information notification device 719 references the correspondence relationship information acquired from the switching control device 717 and identifies the base game corresponding to the slot machine game in which the achievement has been reached. Next, the reward information notification device 719 grants to the user of the identified base game a reward according to the achievement indicated by the achievement information. When this is done, if there are a plurality of base games, the reward information notification device 719 distributes the reward uniformly between the base game users.

(Game Machine Operation)

The operation of the game machine 2 will now be described, starting with an overview of the operation of the game machine 2.

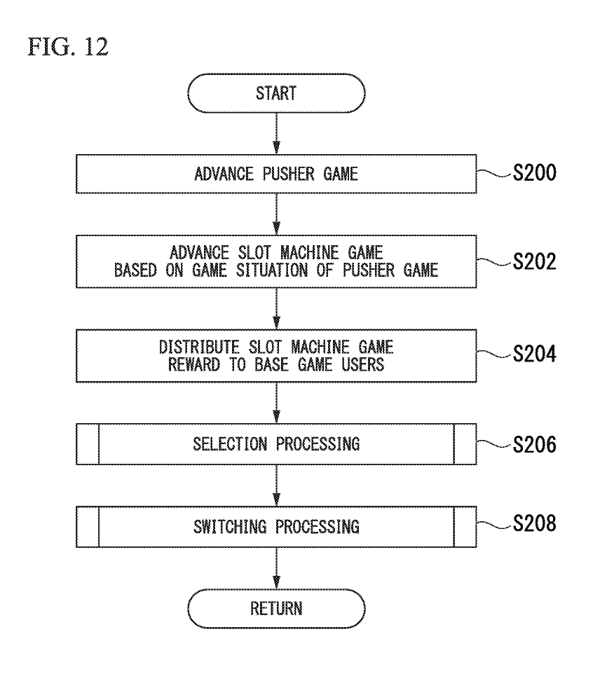

FIG. 12 is as flowchart showing the operation of the game machine 2 according to the present embodiment.

First, the unit managing device 71 causes the pusher game executing device 721 at each station unit ST to advance the pusher game (step S200). Next, the unit managing device 71 causes the slot machine game executing device 723 to advance the slot machine game, based on the game situation in the base game pusher game (step S202). When this is done, if the play mode of the slot machine game is the group play mode, in a prescribed number of a plurality of pusher games participating in the group play mode (for example, all, 80 percent of them, or five or more of them), if a prescribed condition is satisfied, the slot machine game is advanced. The slot machine game may be advanced if the prescribed condition is satisfied in any of the plurality of pusher games participating in the group play mode.

Next, the unit managing device 71 distributes a slot machine game reward to the users of that base game (step S204). Next, the unit managing device 71 executes selection processing to select a pusher game to be made the base game of the slot machine game (step S206). Next, the unit managing device 71 executes switching processing to switch the base game to the selected pusher game (step S208), after which the unit managing device 71 returns to the processing of step S200.

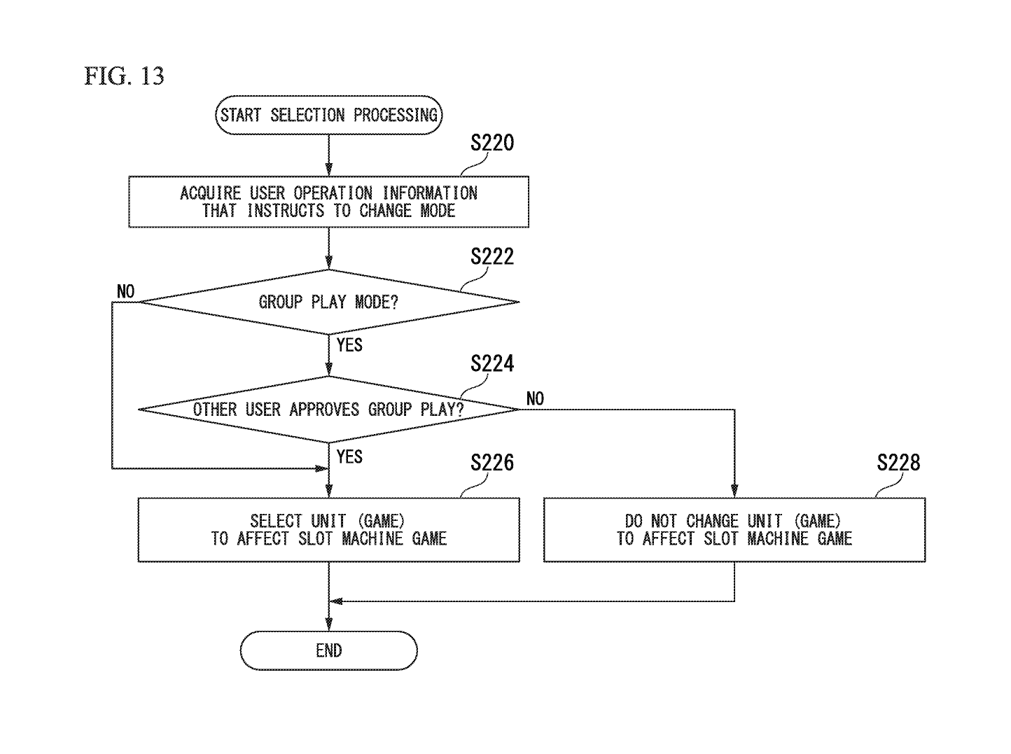

Next, the selection processing by the game machine 2 will be described. In this case, three patterns of the selection processing, corresponding to (1) to (3), will be described, with references made to FIG. 13 to FIG. 15. First, the selection of the base game based on a user operation will be described.

FIG. 13 is a flowchart showing the first example of the flow of selection processing by the game machine 2 according to the present embodiment.

First, the user operation information acquisition device 711 of the unit managing device 71 acquires user operation information indicating a change in the play mode of the slot machine game (step S220). Next, the selection device 715 of the unit managing device 71 determines whether or not the instructed play mode is the group play mode (step S222). If the instructed mode is the group play mode (YES at step S222), the selection device 715 requests the other users in the group play to approve execution of the group play mode, and determines whether or not the other user has given approval (step S224). In this case, the other users in the group play mode may be instructed to make an operation, or any or all of the users to play at the plurality of station units ST may be selected in the unit managing device 71. If the other player in the group play has given approval (YES at step S224), the selection device 715 makes the pusher game that is to be executed at the station units ST to be operated by the user that has instructed the change of the play mode and the other user the base game of one slot machine game to be executed at the two station units ST (step S226). At step S224, if the other user did not give approval (NO at step S224), the selection device 715 does not change the relationship between the current slot machine game and the base game thereof.

At step S222, if the instructed play mode is not the group play mode, that is, if the instructed play mode is the individual play mode (NO at step S222), the selection device 715 makes the pusher games to be executed at each station unit ST the base games of the slot machine games to be executed at each station unit ST (step S226), after which the unit managing device 71 ends the processing shown in FIG. 13.

Next, the base game selection based on the relationship type between users will be described.

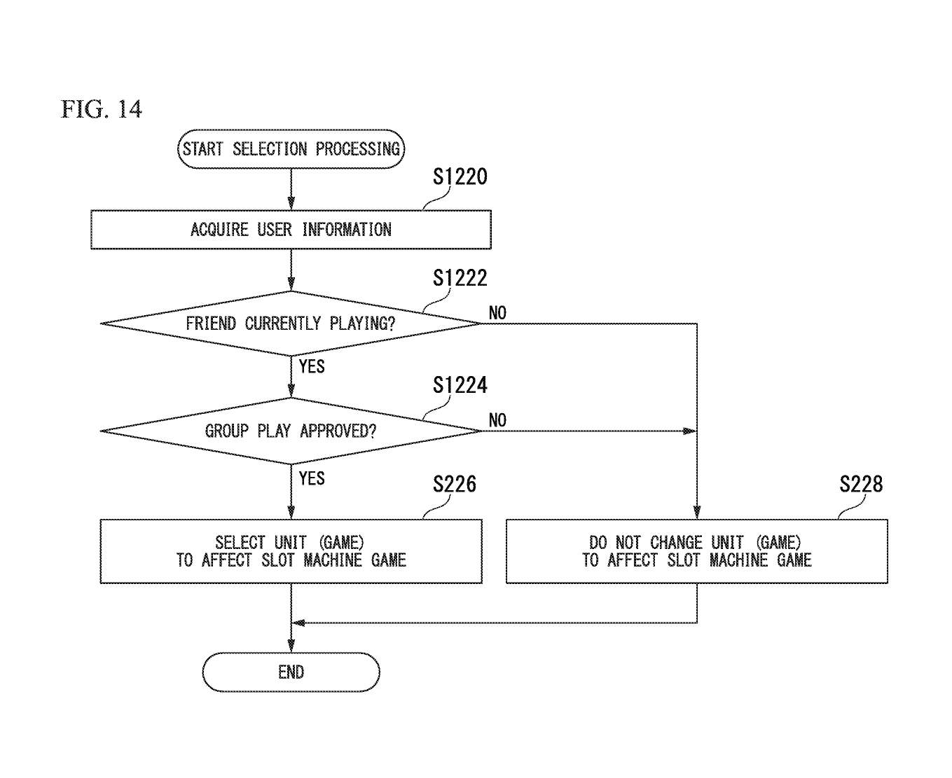

FIG. 14 is a flowchart showing the second example of the flow of selection processing by the game machine 2 according to the present embodiment.

Of the processing shown in FIG. 14, because the processing of steps S226 and S228 are the same as the processing of steps S226 and S228 shown in FIG. 13, their descriptions will be omitted.

First, the user information acquisition device 712 of the unit managing device 71, based on user identification information read from a card 4 presented by the user by the card reader 24 of the operation device 3, acquires the user information of the user from the center server 5 (step S1220). The selection device 715 of the unit managing device 71 identifies a friend user based on the acquired user information, and acquires the user information of the identified friend user from the center server 5 (step S1220). Next, the selection device 715 references the user information of the friend user and determines whether or not the friend user is currently playing (step S1222). If the friend user is not currently playing (NO at step S1222), the selection device 715 proceeds to the processing of step S228. If the friend user is currently playing (YES at step S1222), the selection device 715 requests all users in a friend relationship to approve execution of the group play mode to determine whether or not each of the users approves the group play (step S1224). If all users give approval (YES at step S1224), the selection device 715 proceeds to the processing of step S226. If at least one of the users does not give approval (NO at step S1224), the selection device 715 proceeds to the processing of step S228. After that, the unit managing device 71 ends the processing shown in FIG. 14. In place of steps S1220 and S1222, the user information corresponding to the user identification information read at each station unit ST may be acquired from the center server 5, and a determination may be made of whether or not users playing at the station units ST are in a friend relationship, based on each user information.

Next, base game selection based on a facility or equipment setting will be described.

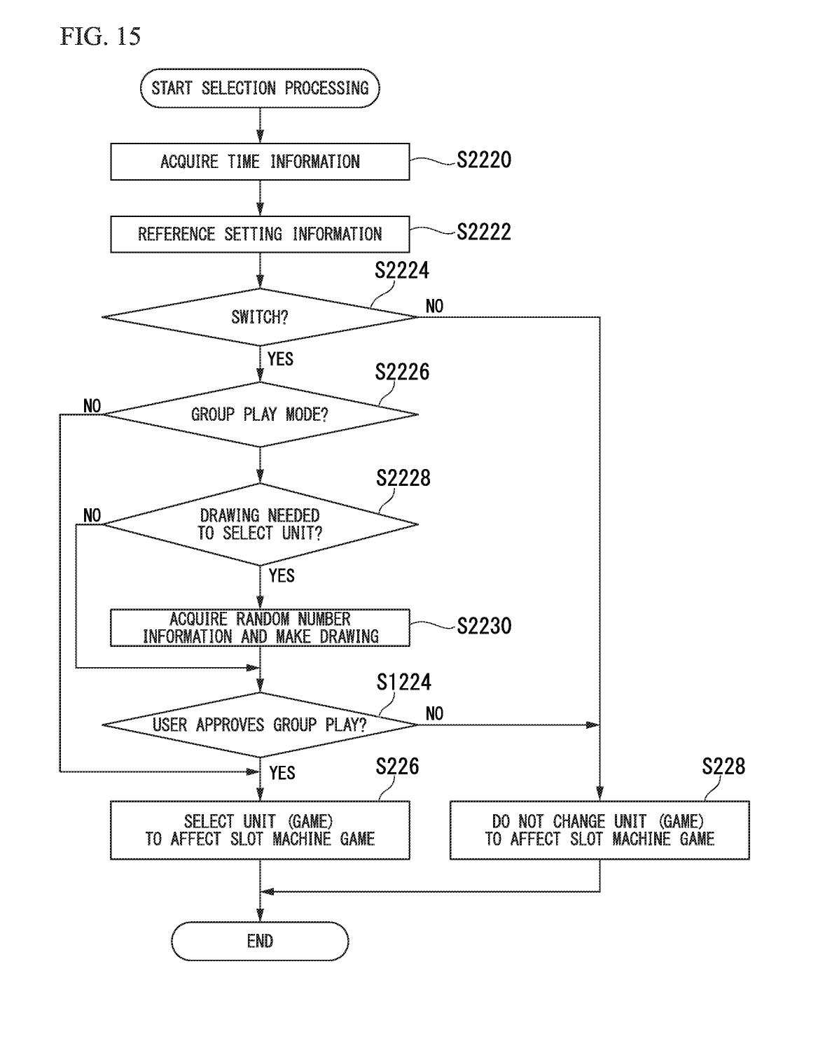

FIG. 15 is a flowchart showing the third example of the flow of selection processing by the game machine 2 according to the present embodiment.

Of the processing shown in FIG. 15, because the processing of steps S226 and S228 are the same as the processing of steps S226 and S228 shown in FIG. 13, their descriptions will be omitted. Also, of the processing shown in FIG. 15, because the processing of step S1224 is the same as the processing of step S1224 shown in FIG. 14, the description thereof will be omitted.

The time information acquisition device 713 of the unit managing device 71 acquires time information indicating the current date and time (step S2220). Next, the selection device 715 of the unit managing device 71 reads the facility/equipment data 77 from its own storage 73 and references the setting information (Step S2222). Next, the selection device 715 of the unit managing device 71 determines whether or not to perform switching of the correspondence relationship between the slot machine game and the base game (step S2224). Specifically, for example, the selection device 715 determines whether or not the correspondence relationship set in the setting information beforehand between the slot machine game and the base game with respect to the current date and time is different from the current state. If the correspondence relationship set beforehand is the same as the current state, that is, when switching will not be done (NO at step S2224), the selection device 715 proceeds to the processing of step S228.

If the correspondence relationship set beforehand is different than the current state, that is, if switching is to be done (YES at step S2224), the selection device 715 determines whether or not the play mode set beforehand is the group play mode (step S2226). If the play mode set beforehand is not the group play mode, that is, in the case of the individual play mode (NO at step S2226), the selection device 715 proceeds to the processing of step S226). If the play mode set beforehand is the group play mode (YES at step S2226), the selection device 715 determines whether or not selection of the combination of station units ST by a drawing is set (step S2228).

If selection of the combination of station units ST by a drawing is set (YES at step S2228), the random number information acquisition device 714 generates a random number (step S2230). The selection device 715, based on the random number generated by the random number information acquisition device 714, selects the combination of station units ST in the group play mode, that is, the combination of pusher games to be made the base game. If selection of the combination of station units ST by a drawing is not set and the combination is directly specified (NO at step S2228), the selection device 715 proceeds to the processing of step S1224). When the selection device 715 executes the processing of step S226 or step S228, the processing shown in FIG. 15 is ended. If selection of the combination of station units ST is not made by drawing, and a combination set beforehand is selected, the processing of steps S2228 and S2230 is unnecessary. If user approval is not to be requested when switching, the processing of step S1224 is not necessary.

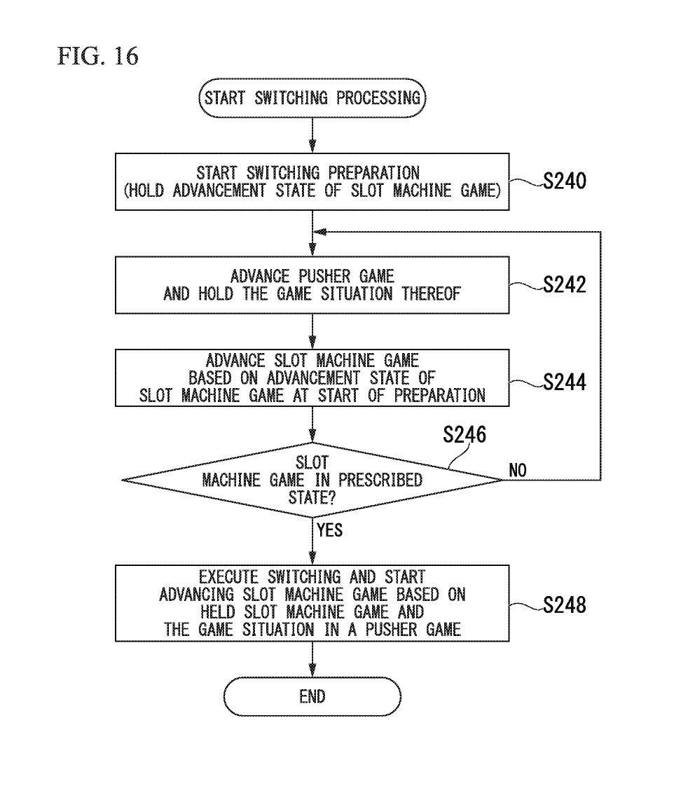

Next, the switching processing by the game machine 2 will be described. FIG. 16 is a flowchart showing an example of the flow of switching processing by the game machine 2 according to the present embodiment.

First, the switching control device 717 of the unit managing device 71 acquires correspondence relationship information from the selection device 715 and starts preparation for switching (step S240). When this is done, the switching control device 717 holds the advancement state of the slot machine game. More specifically, the switching control device 717, for example, holds information such as the game mode of the slot machine game (normal mode or special mode) and the number of reserved drawings. Next the switching control device 717 causes the pusher game to advance in each station unit ST that is a switching target and holds the game situations thereof (step S242). Next, the switching control device 717, based on the advancement state of the slot machine game at the point in time of step S240, causes the slot machine game to advance (step S244). Specifically, based on the number of reserved drawings accumulated in the slot machine game up to the point in time of step S240, a slot machine game drawing is executed. Next, the switching control device 717 determines whether or not the slot machine game is in a prescribed state (step S246). Specifically, the switching control device 717 determines whether or not the state of the slot machine game is one in which all of the number of reserved drawings have been consumed (step S246).

If the slot machine game is not in a prescribed state (NO at step S246), the switching control device 717 returns to the processing of step S242. If the slot machine game is in the prescribed state (YES at step S246), the switching control device 717 switches the correspondence relationship between the slot machine game and the base game thereof, based on the corresponding relationship information acquired at step S240. The slot machine game advance is started from the state of advancement in accordance with the game state of the slot machine game state that had been held by the processing of step S240 and the game state of the base game that had been held by the processing of step S242 (step S248). Specifically, the switching control device 717 starts the slot machine game after switching in the game mode of the slot machine game at the point in time of starting the preparation for switching. The switching control device 717 starts the slot machine game from the state in which the number of reserved drawings acquired in the base game pusher game from the start of preparation for switching up until the completion of switching are held. After that, the unit managing device 71 ends the processing shown in FIG. 16.

(Recaps of the First Embodiment)

(1) As described above, the game system according to the present embodiment has a game machine 2 that can provide a slot machine game (an example of a secondary game) that advances based on the game situation in one or more pusher games (an example of a game). The game machine 2 has a selection device 715 (an example of a selection device) and a slot machine game executing device 723 (an example of a game control device). The selection device 715 selects a different number of pusher games as games that affect the slot machine game, that depends on prescribed information (for example, user operation information, time information, random number information, and setting information).

By doing this, because, for example, the game system 1 can switch between individual play and group play, it can provide a diversity of types of play.

(2) The selection device 715 (an example of a selection device) according to the present embodiment acquires information (for example user information) indicating the relationship type between a plurality of users as the prescribed information, and selects a different number of pusher games as games that affect a slot machine game (an example of a secondary game) that depends on the relationship type between the plurality of users.

By doing this, because, for example, the game system 1 can cause the advance of the secondary game to reflect the game situation of a game being played by users in a friend relationship, users can enjoy a game with an actual friend.

(3) The selection device 715 (an example of a selection device) according to the present embodiment acquires as the prescribed information time information and selects as games that affect the slot machine game (an example of a secondary game) a different number of pusher games that depends on the time.

The game system 1, by doing this, can change the base game in accordance with the time. Therefore, for example, even if a user plays a pusher game for a long time, the user can play a slot machine game with a different play mode. For that reason, the game system 1 can have a user play for a long time without getting bored.

(4) The selection device 715 (an example of a selection device) according to the present embodiment acquires the prescribed information and user operation information and selects as a game that affects the slot machine game (an example of a secondary game) a number of games that depends upon the content of the user operation.

By doing this, because, for example, the game system 1 makes a game specified by the user as the base game, it can meet the desires of the user.

(5) The selection device 715 (an example of a selection device) according to the present embodiment acquires the prescribed information and random number information and selects a number of games that affect the slot machine game (an example of a secondary game) that depends on random number.

By doing this, because, for example, the game system 1 can randomly change the base game, it can continue to provide a game, without having the user become bored.

(6) If a selection by the selection device 715 (an example of a selection device) changes the game that affects the slot machine game (an example of the secondary game), the slot machine game executing device 723 (an example of a game control device) according to the present embodiment uses information of the advancement state of the slot machine game before the change (for example, the number of reserved drawings) to advance the slot machine game after the change.

By doing this, for example, even if the game system 1 changes the correspondence relationship between the base game and the secondary game changes during advancement of the game, it is possible after the change to continue with the game state up until then. Specifically, for example, because the special game mode can be maintained before and after the change, it is possible to reduce the resistance on the part of a user with regard to changing the correspondence relationship.

(7) The slot machine game executing device 723 (an example of a game control device) according to the present embodiment, if a selection by the selection device 715 (an example of a selection device) changes the game that affects slot machine game (an example of a secondary game), advances the slot machine game before the change up to a prescribed game situation (for example, the number of reserved drawings being zero), after which it advances the slot machine game after the change.

By doing this, even if the game system 1 changes the correspondence relationship between the base game and the secondary game during advancement of the game, it can start the secondary game after returning it to a prescribed state. Specifically, because the game machine 2 performs switching of the correspondence relationship after consuming the number of reserved drawings accumulated before the switching, it can reduce the resistance on the part of a user with regard to changing the corresponding relationship.

(8) If a plurality of pusher games are selected by the selection device 715 (an example of a selection device) as games that affect the slot machine game (an example of a secondary game), the slot machine game executing device 723 (an example of a game control device) according to the present embodiment advances the secondary game with the condition that a prescribed game situation (for example, the state in which a medal M has passed through the checker 37) has occurred in at least a prescribed number (for example, one) of the selected plurality of pusher games.

By doing this, if the group play mode is executed, the game system 1 advances the slot machine game when a prescribed achievement is reached in a prescribed number of users participating in group play (ANDed condition). By doing this, the game system 1 can heighten the sense of connection between users.

(9) If the selection device 715 (an example of a selection device) selects a plurality of pusher games as games that affect the slot machine game (an example of a secondary game), the slot machine game executing device 723 according to the present embodiment advances the slot machine game with the condition that a prescribed game situation (for example, the state in which a medal M has passed through the checker 37) occurs in one of the selected plurality of pusher games.

By doing this, if the group play mode is executed, the game system 1 advances the secondary game when any one user participating in group play reaches a prescribed achievement. By doing this, the game system 1 can heighten the motivation of a user with respect to group play, thereby enabling having more users participate in a game.

(10) If the selection device 715 (an example of a selection device) selects a plurality of pusher games as games that affect the slot machine game (an example of a secondary game), the slot machine game executing device 723 according to the present embodiment distributes a slot machine game reward to each user playing the plurality of selected pusher games.

By doing this, for example, if the group play mode is executed, the game system 1 distributes a reward to users participating in group play, thereby enabling each of the users participating in group play to obtain a slot machine game reward.

### Second Embodiment

(Game System Overview)

The second embodiment of the present invention will now be described.

The game system 1 according to the present embodiment has the same configuration as the game system 1 according to the first embodiment. However, whereas in the first embodiment the secondary game that advances based on the game situation in the pusher game is a slot machine game, in the present embodiment the secondary game is a bingo game.

(Bingo Game Individual Play Mode)

The bingo game of the present embodiment will now be described.

The bingo game of the present embodiment, similar to the slot machine game according to the first embodiment, has an individual play mode and a group play mode. The game machine 2 advances the game in different way, depending upon the play mode. First, the bingo game in the individual play mode will be described.

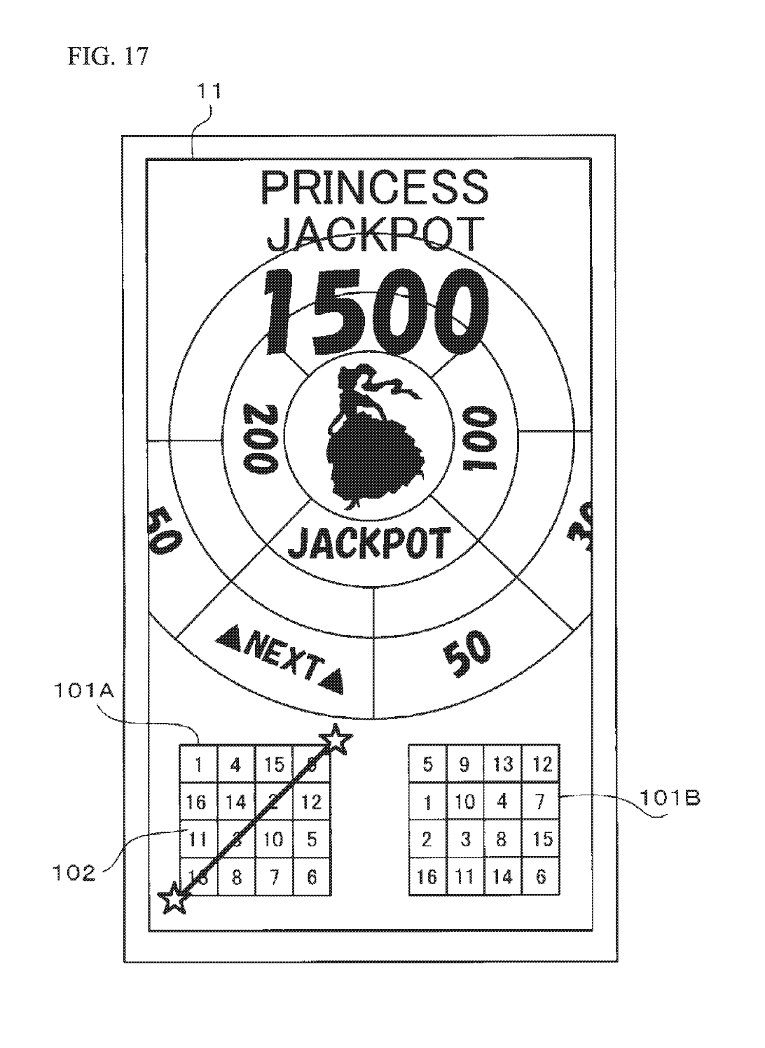

FIG. 17 is a first drawing for describing a bingo game according to the present embodiment.

In the individual play mode, one bingo sheet 101 is displayed on the first monitor 11 for each station unit ST. In the example shown in FIG. 17, the bingo sheets 101A and 101B are displayed in the bottom part of the first monitor 11. In the individual play mode, the bingo sheets 101A and 10113 are each associated with different station units ST. In the individual play mode, the bingo sheets 101A and 101B are associated with mutually different station units ST. Specifically, the bingo game of the bingo sheet 101A advances based on the game situation in the pusher game of the first station unit ST1, and the bingo game of the bingo sheet 101B advances based on the game situation in the pusher game of the second station unit ST2.

Next, as one example, the relationship between the game situation in the pusher game at the first station unit ST1 and the advancement of the bingo game on the bingo sheet 101A will be described.

The bingo sheet 101A has 16 squares, in four rows and four columns, with each square 102 assigned bingo numbers from 1 to 25. Bingo numbers from 1 to 25 are allocated to the bingo medals M4 in the pusher game. The IC chip in a bingo medal M4 has recorded therein identification information of the bingo number allocated thereto, and the allocated bingo number is marked on the surface of the bingo medals M4. In addition, among the bingo medals M4 are those in which is recorded identification information of “drawing,” which makes a roulette drawing of the bingo number and “specify,” which activates a bingo number desired by the user. Pictures corresponding to these functions are marked on the surface of these bingo medals M4.

In the pusher game, if a bingo medal M4 drops into the drop chute 34, the IC reader 38 reads the bingo number, and the “drawing” or “specify” that are allocated to the bingo medal M4 that had dropped. Next, the bingo game executing device 722 activates the corresponding bingo square 102 of the bingo sheet 101A based on the read results. Each time a bingo medal M4 drops, the bingo square 102 corresponding to the bingo medal M4 that dropped is activated, and the bingo game advances. When bingo is achieved in the bingo game, the game machine 2 grants to the user a reward, such as the right to play the roulette game. In the individual play mode, the bingo game on the bingo sheet 101B advances in response to bingo medals M4 dropping in the pusher game at the second station unit ST2.

(Bingo Game Group Play Mode)

Next, the bingo game in the group play mode will be described.

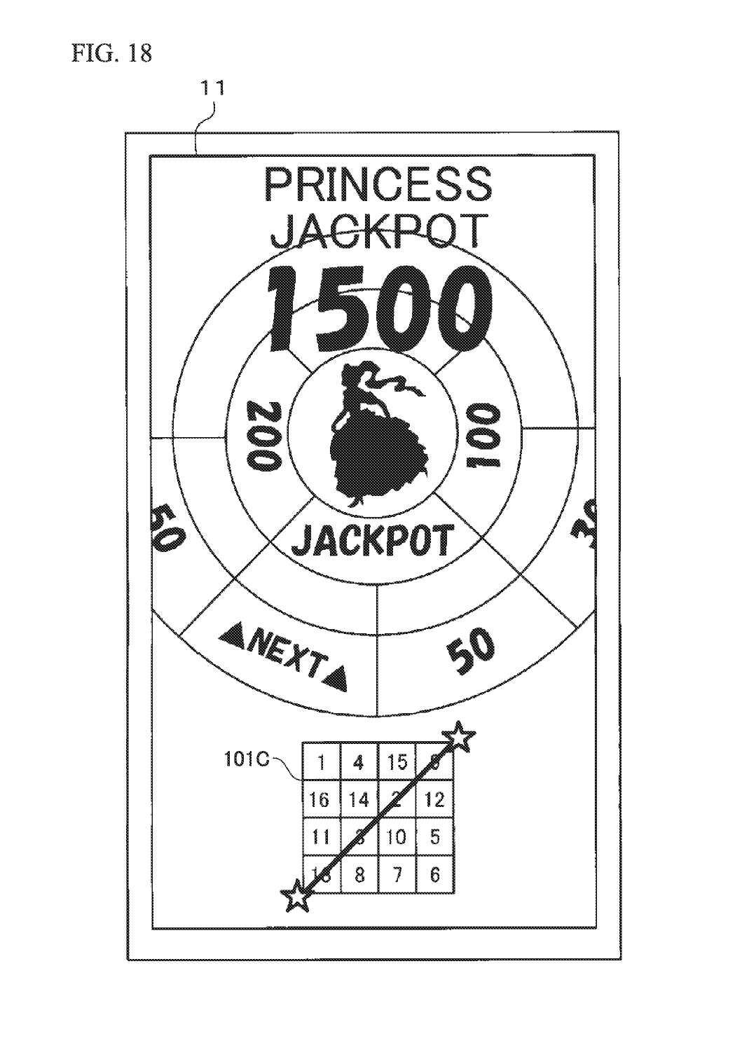

FIG. 18 is the second drawing for describing the bingo game according to the present embodiment.

In the group play mode, one bingo sheet 101C is displayed on the first monitor 11 corresponding to a plurality of station units ST. In the example shown in FIG. 18, one bingo sheet 101C is displayed in the bottom part of the first monitor 11. In the group play mode, the bingo sheet 101C is associated with a plurality of station units ST. Specifically, for example, the bingo game on the bingo sheet 101C advances based on the game situation in the pusher game at the first station unit ST1 and game situation in the pusher game at the second station unit ST2.

In this case, in the p, if a bingo medal M4 drops in either one of the pusher game at the first station unit ST1 and the pusher game at the second station unit ST2 (ORed condition), the bingo game executing device 722 activates the bingo square corresponding to the bingo medal M4 that had dropped. In a different form, if a specific bingo medal M4 drops both in the pusher game at the first station unit ST1 and in the pusher game at the second station unit ST2 (ANDed condition), the bingo game executing device 722 activates the bingo square corresponding to the specific bingo medal M4. In this manner, the game machine 2 may make the bingo game the secondary game, in place of the slot machine game according to the first embodiment.

In the group play mode, although in the above-noted example a bingo sheet is provided in common to a plurality of users participating in the group play mode, different bingo sheets may be provided to each user in the same manner as in the individual play mode. In this case, in contrast to the individual play mode, the achievement in the pusher game by any one of the users participating in the group play mode is reflected not only in the bingo sheet of that user, but also in the bingo sheets of other users.

(Recaps of the Second Embodiment)

As described above, a game system according to the present embodiment has a game machine 2 that can provide a bingo game (an example of a secondary game) that advances based on the game situation in one or more pusher games (an example of a game). The game machine 2 has a selection device 715 (an example of a selection device) and a slot machine game executing device 723 (an example of a game control device). The selection device 715, as the base game that affects the slot machine game, selects a number of pusher games that depends on the prescribed information (for example, user operation information, user information, time information, random number information, and setting information).

By doing this, because the game system 1, for example, can switch between individual play and group play, it can provide diverse methods of playing.

### Third Embodiment

(Game System Overview)

Next, the third embodiment of the present invention will be described.

The game system 1 according to the present embodiment has the same configuration as the game system 1 according to the first embodiment. However, whereas in the first embodiment the base game is a pusher game and the second game is a slot machine game, in the present embodiment the base game is a slot machine game or a bingo game and the secondary game is a roulette game.

The overview of base game selection by the game machine 2 according to the present embodiment will now be described.

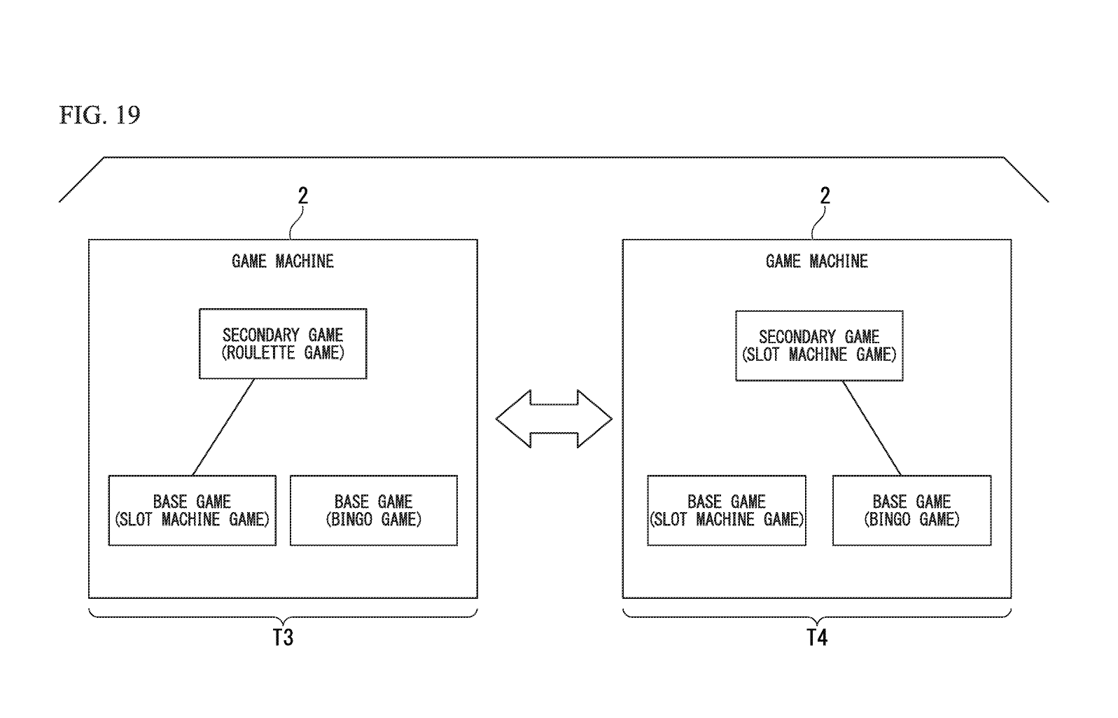

FIG. 19 is a conceptual drawing of base game selection according to the present embodiment.

FIG. 19 shows two states, T3 and T4, as examples of the relationship of correspondence between the base game and the secondary game. In the state T3 and the state T4, one base game is associated with one secondary game. However, the base games that are associated with the secondary game is different between the two states T3 and T4. In this manner, the game machine 2 according to the present embodiment selects from base games of different types, based on prescribed information.

(Roulette Game)

Next, the roulette game according to the present embodiment will be described.

The roulette game according to the present embodiment grants a reward to a user in accordance with the result of a drawing by a roulette wheel. The roulette wheel may be an internal drawing that is made by software, or may be a so-called physical drawing mechanism. The case of a roulette game performed by a physical drawing mechanism will be described.

A physical drawing mechanism according to the present embodiment will now be described.

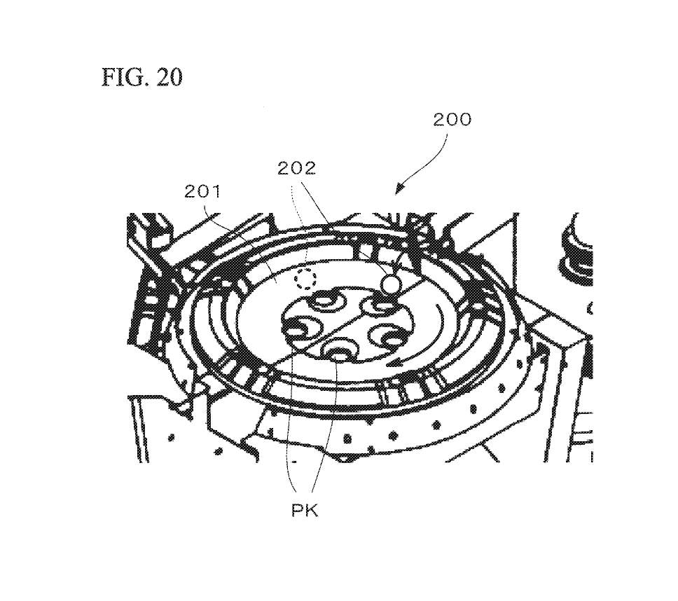

FIG. 20 shows an oblique view of a physical drawing mechanism according to the present embodiment.

In the physical drawing mechanism 200 shown in FIG. 20, a ball 202, as the playing medium, are inserted onto the disk-shaped game field 201, and the drawing result is established when a ball 202 passes through and drops into any one of a plurality of pockets PK as the medium passage positions. The game field 201 may rotate as indicated by the arrow or may not rotate. In a physical drawing mechanism 200 such as this, only a part of the plurality of pockets PK are set as winning positions, and the drawing is made by win occurring when a ball 202 pass through pocket PK as a winning position. In this case, because the winning probability changes depending upon the number of pockets PK as winning positions, the number of winning positions may be set so as to change in accordance with the game mode of the roulette game. Alternatively, because the winning probability also changes in accordance with the number of balls 202 inserted, the number of balls 202 may be set so as to change in accordance with the game mode of the roulette game.

The roulette game advances based on the game situation in the slot machine game or the bingo game set as the base game. If a prescribed condition is satisfied in the base game, the roulette game executing device 724 executes a drawing and advances the roulette game. In this case, the prescribed condition is, for example, the arrangement of a specific picture in the slot machine game or the achievement of bingo in a bingo game.

(Selection Processing)

Next, selection of the base game will be described.

The selection device 715 according to the present embodiment, similar to that of the first embodiment, performs processing to select the base game. In the present embodiment, however, because the base game is a slot machine game or a bingo game, the selection device 715 makes one of the slot machine game and the bingo game the base game of the roulette game.

The selection device 715 selects the base game based on prescribed information such as user operation information or setting information. If the base game is to be selected based on user operation information, the user operation information is, for example, an operation to specify the base game accepted by the operation device 3 from the user. The selection device 715 then selects the base game of the roulette game based on the specification from the user.

If the base game is to be selected based on setting information, the setting information includes, for example, base game information (base game) in place of unit information. The base game information represents the base game of the roulette game. The value of the base game information includes either one of the slot machine game and the bingo game. The value of the base game information may indicate, for example, the selection of either the slot machine game or the bingo game by a drawing.

(Recaps of the Third Embodiment)

As described above, the game system 1 (an example of a game system) according to the present embodiment has a game machine 2 (an example of a game system) that can provide a roulette game (an example of a secondary game) that advances based on the game situation in one or more slot machine games or bingo games (an example of a game). The game machine 2 has a selection device 715 (an example of a selection device) and a roulette game executing device 724 (an example of a game control device). The selection device 715 selects as the base game that affects the slot machine game a type of game (for example a slot machine game or a bingo game) differs based on prescribed information (for example, user operation information, user information, random number information, and setting information).

By doing this, because the game system 1 can select games that differ in type as the base game of the secondary game, it can provide diverse methods of playing.

### Fourth Embodiment

(Game System Overview)

The fourth embodiment of the present invention will now be described.

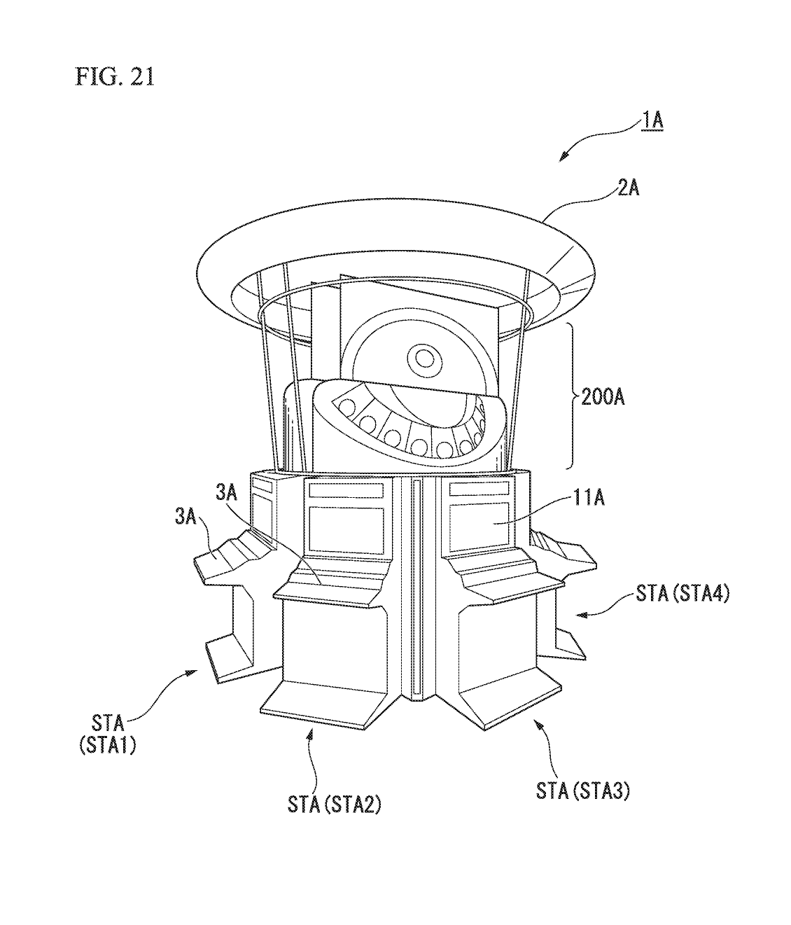

FIG. 21 is an overall view of a game machine 2A according to the present embodiment.

In the game system 1A according to the present embodiment (FIG. 21), a game machine 2A (FIG. 21) is provided in place of the game machine 2 (FIG. 1) provided by the game system 1 (FIG. 1) according to the first embodiment. The game machine 2A, similar to the game machine 2, can provide users with one or more base games and a secondary game. In the game machine 2A, however, the type of games provided differs from the game machine 2. Specifically, the game machine 2A provides a so-called casino game, such as a baccarat game, a poker game, a slot machine game, a roulette game, a blackjack game, a craps game, or a sic bo game. In the following, the description is for the case in which at least one of a baccarat game, a poker game, a slot machine game, a blackjack game, a craps game, or a sic bo game is made as the base game and a secondary game roulette game is advanced.

An overview of base game selection by the game machine 2A according to the present embodiment will now be described.

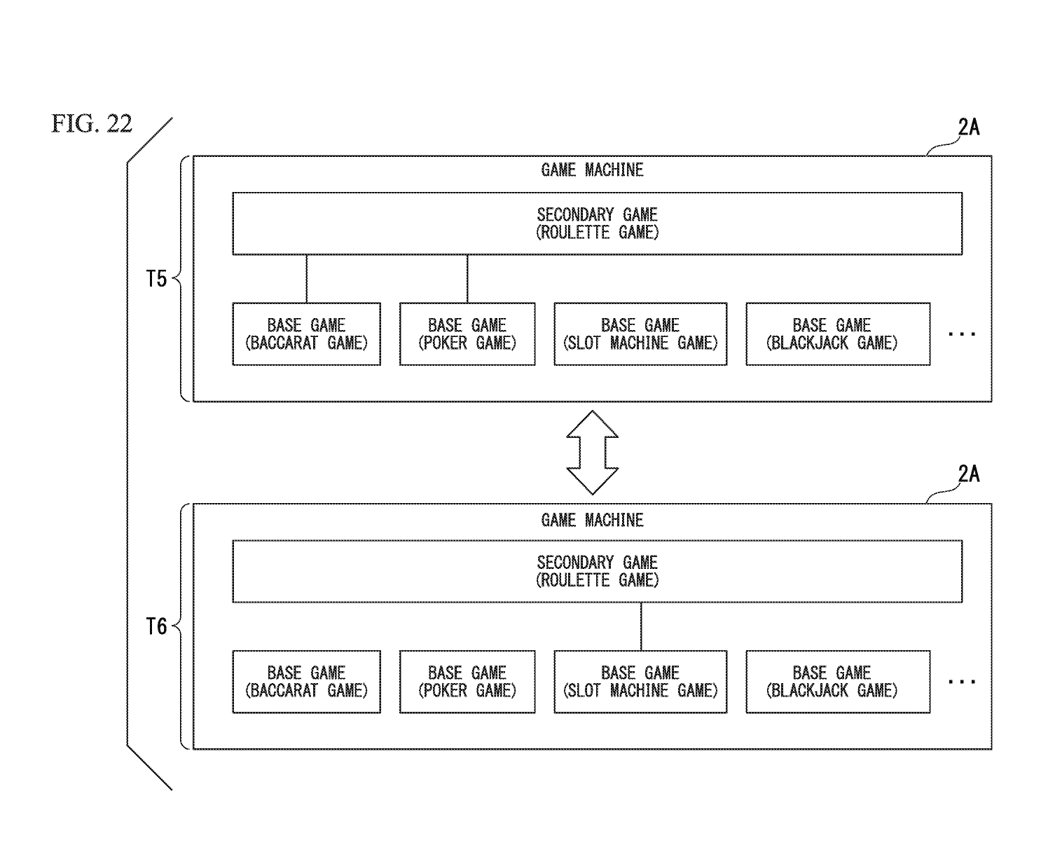

FIG. 22 is a conceptual drawing of base game selection according to the present embodiment.

FIG. 22 shows two states, T5 and T6, as examples of the relationship of correspondence between the base game and the secondary game. In the state T5, two base games are associated with one secondary game. In the state T6, one base game is associated with one secondary game. The base games associated with the same secondary game are of different types between the state T5 and the state T6. In this manner, the game machine 2A according to the present embodiment, based on prescribed information, selects base games that are different in both number and type, or different in one thereof.

(Game Machine Configuration)

Next, the configuration of the game machine 2A will be described, with reference made to FIG. 21.

The game machine 2A has physical drawing mechanism 200A and six station units STA. The physical drawing mechanism 200A makes a physical drawing in a roulette game. Each station unit STA has an operation device 3A and a monitor 11A. Each station unit STA displays on the monitor 11A a game screen of, for example, a baccarat game, a poker game, a slot machine game, a blackjack game, a craps game, or a sic bo game. The operation device 3A accepts operations and the like from a user of the game displayed on the monitor 11A.

(Game Machine Control System Configuration)

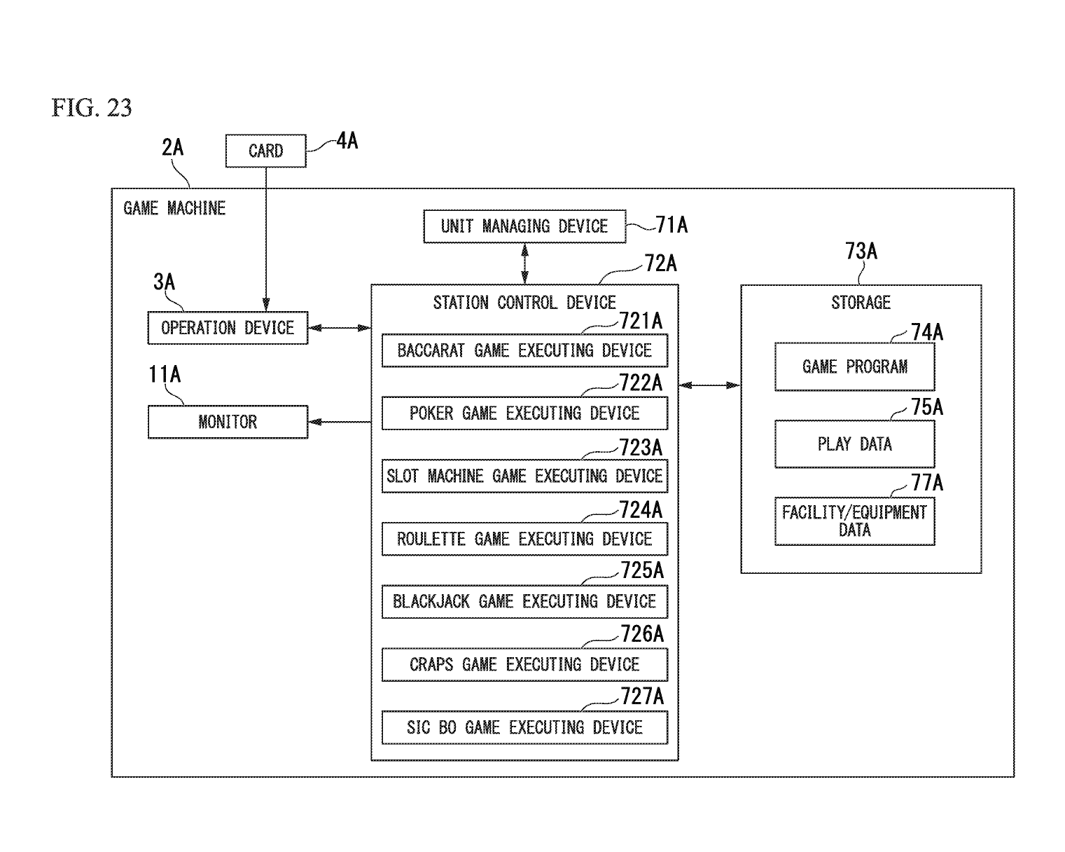

FIG. 23 is a block diagram showing the general functional configuration of the game machine 2A according to the present embodiment.

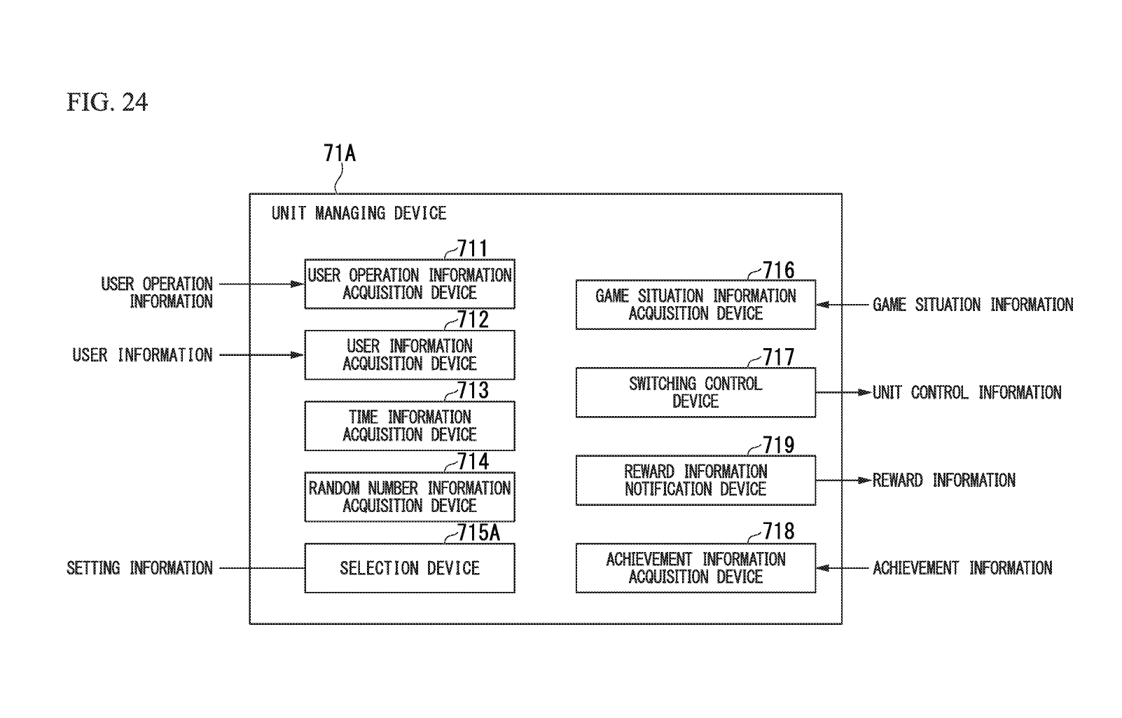

FIG. 24 is a block diagram showing the general functional configuration of the unit managing device according to the present embodiment.

The game machine 2A has, in place of the unit managing device 71 (FIG. 8), the station control device 72 (FIG. 8), and the storage 73 (FIG. 8) of the game machine 2 according to the first embodiment, a unit managing device 71A (FIG. 23), a station control device 72A (FIG. 23), and a storage 73A (FIG. 23). The unit managing device 71A has, in place of the selection device 715 (FIG. 8) according to the first embodiment, a selection device 715A (FIG. 24).

The station control device 72A controls each of the station units STA of the game machine 2A. The station control device 72A has a baccarat game executing device 721A that executes a baccarat game, a poker game executing device 722A that executes a poker game, a slot machine game executing device 723A that executes a slot machine game, a roulette game executing device 724A that executes a roulette game, a blackjack executing device 725A that executes a blackjack game, a craps game executing device 726A that executes a craps game, and a sic bo game executing device 727A that executes a sic bo game. If a plurality of base games are selected by the unit managing device 71A, the station control device 72A, for example, may display the game screens of the selected base games next to each other on the monitor 11A, or may display them one at a time, switching them in accordance with time, a user operation, or the like.

The storage 73A is a device that includes a non-volatile storage medium such as a magnetic storage medium, an optical storage medium, or an EEPROM. The storage 73A stores a game program 74A for execution of a game by the game machine 2A, play data 75A, and facility/equipment data 77A indicating the facility in which the game machine 2A is installed and setting information for each game machine 2A. The storage 73A also stores various data necessary for the execution of a game. The play data 75A is data into which is saved the content of game play for the purpose of a player continuing with the play of a game from midway. The play data 75A has recorded therein data regarding the results of various games played by and items and the like acquired by the player.

(Selection Processing)

Next, selection of the base game will be described.

The selection device 715A according to the present embodiment, similar to the selection device 715 according to the first embodiment, performs processing to select the base game. In the present embodiment, however, the base game is selected from among a plurality of games that can be played at one station unit STA.

The selection device 715A selects the base game based on prescribed information, such as user operation information and setting information. If the base game is to be selected based on user operation information, the user operation information is, for example, an operation to specify the base game accepted by the operation device 3 from the user. The selection device 715A then selects the base game of the roulette game based on the specification from the user.

If the base game is to be selected based on setting information, the setting information includes, for example, base game information (base game). The base game information represents the base game of the roulette game. The base game information includes at least one from among, for example, a baccarat game, a poker game, a slot machine game, a blackjack game, a craps game, and a sic bo game. The base game information, for example, may indicate, for example, the selection of at least one game of these various types of games by a drawing.

Although the case of selecting the base game from a plurality of games that can be played at one station unit STA has been described, a plurality of base games may be selected from a plurality of station units STA, in which case the selection device 715A may determine the type of relationship between users, based on user information and may make the game being played by users in a friend relationship as the base game.

(Recaps of the Fourth Embodiment)

As described above, the game system 1A according to the present embodiment (an example of a game system) has a game machine 2A (an example of a game system) that can provide a roulette game (an example of a secondary game) advancing based on one or more of a baccarat game, a poker game, a slot machine game, a blackjack game, a craps game, and/or a sic bo game (an example of a game). The game machine 2A has a selection device 715A (an example of a selection device) and a roulette game executing device 724A (an example of a game control device). The selection device 715A selects base games that differ in number and/or type (for example, a baccarat game, a poker game, a slot machine game, a blackjack game, a craps game, and/or a sic bo game) as a base game that affects the roulette game, in accordance with prescribed information (for example, user operation information, user information, time information, random number information, and setting information).

By doing this, the game system 1A, for example, can select and switch games that differ in at least one of number and type from among various casino games that can be played at the same enclosure. For that reason, for example, because a user can select a desired type of game as the base game, the game system 1A can provide a diversity of types of playing.

(Modified Examples)

Although embodiments of the present invention have been described above with references made to the drawings, the specific configuration thereof is no restricted to the above-described embodiments, and includes designs and the like that are within the scope of the spirit of the present invention. For example, the various constituent elements described in the above-described first to fourth embodiments may be arbitrarily combined.

The configuration of a game system according to such a modified example will now be described.

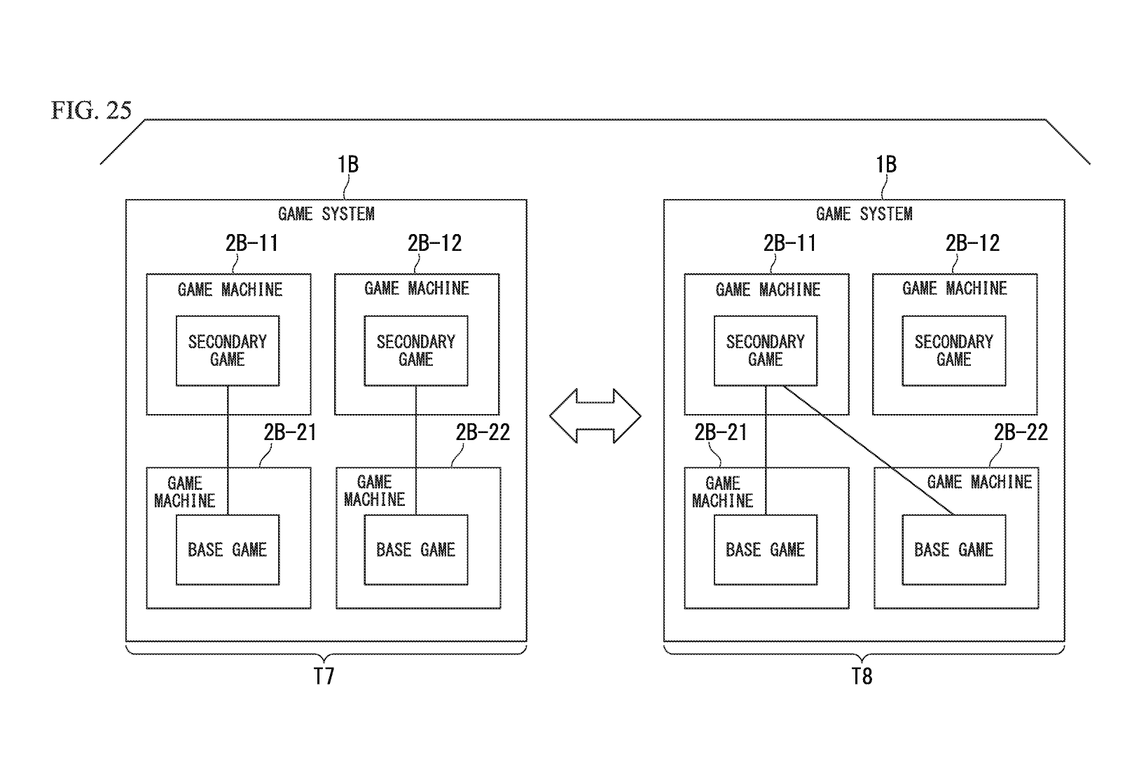

FIG. 25 is a conceptual view of base game selection according to a modified example.

In the above-described embodiments, the description has been for the case in which a base game and a secondary game are executed by a game machine 2, 2A that is executed in a single device. The base game and the secondary game, however, may be executed in separate devices. Specifically, the game system 1B according to the modified example, as one example, has game machines 2B-11, 2B-12 that executes the secondary game and game machines 2B-21, 2B-22 that executes the base game. In this case, each of the game machines 2B-11, 2B-12, 2B-21, 2B-22 are connected via the network N and can communicate with the others.

In the state T7 of FIG. 25, the secondary game of the game machine 2B-11 is associated with the base game of the game machine 2B-21, and the secondary game of the game machine 2B-12 is associated with the base game of the game machine 2B-22. In the state T8 of FIG. 25, the secondary game of the game machine 2B-1 1 is associated with two games, the base game of the game machine 2B-21 and the base game of the game machine 2B-22. In the game system 1B when the base game is selected based on prescribed information, for example, switching is done between the state T7 and the state T8. In the game system 1B, the selection device may be provided in any one of the game machines 2B-11, 2B-12, 2B-21, and 2B-22, or may be provided in another device. The game machines 2B-11, 2B-12, 2B-21, and 2B-22 may each be installed in mutually different facilities or in the same facility.

In the above-described embodiments, the combination of the base game and the secondary game is not restricted to those described. For example, arbitrary games of various types described above may be taken to be the base game that affects another arbitrary game. For example, there is a case in which a game described as the secondary game in the above-described embodiments is the base game, and a game described as the base game is the secondary game. Specifically, for example, in the game system 1 according to the first embodiment, if medals are supplied to the field of a pusher game as the reward in a slot machine game, that slot machine game is the base game that affects the pusher game, and the pusher game is the secondary game that advances based on the game situation in the slot machine game.

In the embodiments described above, the selection devices 715, 715A may select the base game based on an arbitrary combination from among user operation information, user information, time information, random number information, and setting information. The selection devices 715, 715A may also select the base game based on prescribed information other than the above-noted information. Specifically, for example, the selection devices 715, 715A may select the base game based on information of the shop in which the game machines 2, 2A are installed, in which case, for example, the selection devices 715, 715A associate with one secondary game only a game executed by game machines 2, 2A installed in the same group of stores.

A program for implementing the functions of the above-described game machines 2, 2A and center server 5 may be recorded in a computer-readable recording medium, the program recorded in the recording medium being read into a computer system and executed so as to perform processing as the game machines 2, 2A and center server 5. In this case, “program recorded in recording medium being read into a computer system and executed” includes installation of the program into a computer system. The term “computer system” includes an operating system and hardware such as peripheral devices. The “computer system” may also include a plurality of computers connected via a network, which includes a communication line, such as the Internet, a WAN, a LAN, or a dedicated communication circuit. The term “computer-readable recording medium” refers to a removable medium such as a flexible disk, an optomagnetic disk, a ROM, a CD-ROM, or the like, or a storage device such as a hard-disk drive or the like built into a computer system. In this manner, the recording medium into which the program is stored may be a non-volatile recording medium such as a CD-ROM. The recording medium may be internally or externally provided recording medium that can be accessed from a distribution server for distributing the program. The code of the program stored in the recording medium of the distribution server may be different from the code of a program of a format that can be executed in a terminal device. That is, as long as downloading and installation from a distribution server are done to enable execution in a terminal device, there is no restriction on the format in which storage is done on the distribution server. The program may be divided into multiple parts that are downloaded at different times and merged later at a terminal device, and the divided program parts may be distributed by different distribution servers. Additionally, the term “computer-readable recording medium” includes one holding a program for a given period of time, such as a volatile memory (RAM) within a computer system serving as a server or client in the case in which a program is transmitted via a network. The above-noted program may be for implementing a part of the above-described functionality. Additionally, it may be a so-called difference file (difference program) enabling a combination with a program that already has recorded the above-noted functionality in a computer system.

From the foregoing, the present invention can be understood, for example, as follows. Although, as a convenience to facilitate an understanding of the present invention, reference symbols of the attached drawings are indicated in parentheses, there is no restriction to the illustrated aspects of the present invention.

A game system of one aspect of the present invention has a selection device (715, 715A, S206) that selects the number and/or type of one or more base games, using prescribed information, and a game control device (722, 723, 724, 724A, S202) that starts or advances one secondary game, based on the game situation in the one or more base games selected by the selection device (715, 715A). Examples of the base game include, but are not limited to, a pusher game, a bingo game, a slot machine game, a baccarat game, a poker game, a blackjack game, a craps game, and a sic bo game. Examples of the secondary game include, but are not limited to, a slot machine game, a bingo game, and a roulette game.

According to the above-noted configuration, because the game systems 1, 1A can advance the secondary game based on one or more selected games, it can provide a diversity of playing methods.

Another aspect of the present invention is the above-noted game system (1, 1A), wherein the selection device (715, 715A) acquires (S1220) information indicating the relationship between a plurality of users as the prescribed information and selects (S226) the number and/or type of one or more base games, using at least the above-noted relationship (for example a friend relationship) between the plurality of users.

According to the above-noted configuration, in the game systems 1, 1A a user can play a game individually, or can play a game as a group with another player with whom the player has a relationship.

Another aspect of the present invention is the above-noted game system (1, 1A), wherein the selection device (715, 715A) acquires (S2220) time information as the prescribed information and selects (S226) the number and/or type of the one or more base games, using at least the time information.

According to the above-noted configuration, the game systems 1, 1A can, for example, change the game that affects the advancement of the secondary game in accordance with the time.

Another aspect of the present invention is the above-noted game system (1, 1A), wherein the selection device (715, 715A) acquires (S220) user operation information as the prescribed information, and selects (S226) the number and/or type of the one or more base games, using at least the user operation information.

According to the above-noted configuration, the game systems 1, 1A, for example, can cause a game selected by the user to be reflected in the advancement of the secondary game.

Another aspect of the present invention is the above-noted game system (1, 1A), wherein the selection device (715, 715A) acquires (S2230) random number information as the prescribed information and selects (S226) the number and/or type of the one or more base game, using at least the random number information.

According to the above-noted configuration, because the game systems 1, 1A randomly change the base game that affects the advance of the secondary game, it can continue to provide a game without the user becoming bored.

Another aspect of the present invention is the above-noted game system (1,1A), wherein, if the selection by the selection device (715, 715A) is to change the number and/or type of the one or more base games, the game control device causes the one secondary game to advance (S248) after the change, using information of the game situation of the one secondary game before the change.

According to the above-noted configuration, even if the relationship of correspondence between the base game and the secondary game changes during advancement of the game, for example, the game systems 1, 1A can continue the game from the game state before the change.

Another aspect of the present invention is the above-noted game system (1, 1A), wherein, if the selection by the selection device (715, 715A) is to change the number and/or type of the one or more base games, the game control device causes the one secondary game to advance (S246) after the change, using information of the game situation of the secondary game before the change.

According to the above-noted configuration, even if the relationship of correspondence between the base game and the secondary game changes during the advancement of the game, the game systems 1, 1A can start the secondary game after returning it to a prescribed state.

Another aspect of the present invention is the above-noted game system (1, 1A), wherein, if the selection device (715, 715A) has selected a plurality of games as games that affect the secondary game, the game control device advances the secondary game with the condition that a prescribed game state is satisfied in a prescribed number of games of the plurality of selected games.

According to the above-noted configuration, if a secondary game is provided in the group play mode, for example, the game systems 1, 1A advance the secondary game when a prescribed number of users of the users participating in the group play have reached a prescribed achievement. By doing this, the game systems 1, 1A can heighten the sense of connection between users.

Another aspect of the present invention is the above-noted game system (1, 1A), wherein, if the selection device (715, 715A) has selected a plurality of games as games that affect the secondary game, the game control device advances the secondary game with the condition that a prescribed game state occurs in any one of the plurality of selected games.

According to the above-noted configuration, if the game systems 1, 1A provide a secondary game in the group play mode, they advance the secondary game when any one of the users participating in group play reaches a prescribed achievement. By doing this, the game systems 1, 1A can heighten the motivation of a user with respect to playing in group play. It can therefore cause more users to participate in the game.

Another aspect of the present invention is the above-noted game system (1, 1A), wherein, if the selection device (715, 715A) has selected a plurality of base games, the game control device distributes (S204) among the users playing the plurality of selected base games the one secondary game reward.

According to the above-noted configuration, if the game systems 1, 1A provide a secondary game in the group play mode, for example, they distribute a reward to users participating in the group play. By doing this, each user participating in the group play can obtain a reward regarding the secondary game.

A program of another aspect of the present invention causes a computer (71, 71A, 72) to execute a selection step (S206) that selects the number and/or type of one or more base games, using prescribed information and a game control step (S202) that starts or advances one secondary game, based on the game situation in the one or more base games selected by the selection step (206). Examples of the base game include, but are not limited to, a pusher game, a bingo game, a slot machine game, a baccarat game, a poker game, a blackjack game, a craps game, and a sic bo game. Examples of the secondary game include, but are not limited to, a slot machine game, a bingo game, and a roulette game.

According to the above-noted configuration, because the game machines 2, 2A into which the above-noted program is installed advance the secondary game based on one or more selected games, they can provide a diversity of playing methods.

Each element or device for the game apparatus described above can be implemented by hardware with or without software. In some cases, the game apparatus may be implemented by one or more hardware processors and one or more software components wherein the one or more software components are to be executed by the one or more hardware processors to implement each element or device for the game apparatus. In some other cases, the game apparatus may be implemented by a system of circuits or circuitry configured to perform each operation of each element or device for the game apparatus.

The systems and methods in the above-described embodiments may be deployed in part or in whole through a machine or circuitry that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods, devices, apparatus, and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While certain embodiments of the present inventions have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A game system comprising:
a selection device configured to select, for selecting one or more base games, at least one of a) the number of one or more primary games; and b) a type of the one or more base games, using at least a predefined information; and
a game control device configured to start or advance a secondary game, which is subordinate to the one or more primary games, based at least in part on a game state of the one or more base games selected by the selection device.

2. The game system according to claim 1, wherein the selection device is configured to acquire a user-relationship information representing relationships among users and select the at least one of a) the number of one or more primary games; and b) the type of the one or more base games, using at least the user-relationship information as the predefined information.

3. The game system according to claim 1, wherein the selection device is configured to acquire a time information and select the at least one of a) the number of one or more primary games; and b) the type of the one or more base games, using at least the time information as the predefined information.

4. The game system according to claim 1, wherein the selection device is configured to acquire a user-operation information and select the at least one of a) the number of one or more primary games; and b) the type of the one or more base games, using at least the user-operation information as the predefined information.

5. The game system according to claim 1, wherein the selection device is configured to acquire a random-number information and select the at least one of a) the number of one or more primary games; and b) the type of the one or more base games, using at least the random-number information as the predefined information.

6. The game system according to claim 1,
wherein the game control device is configured to advance the secondary game using a previous advanced state information of the secondary game, in case that the selection device has selected at least one of a different number of the primary games and a different type of the primary games,
where the previous advanced state is a previous state of having advanced the secondary game before the selection device has selected at least one of the different number and the different type,
where the different number of the primary games is different from the number of the primary games that the selection device had selected, and the different type is different from the type of the primary games that the selection device had selected.

7. The game system according to claim 2,
wherein the game control device is configured to advance the secondary game using a previous advanced state information of the secondary game, in case that the selection device has selected at least one of a different number of the primary games and a different type of the primary games,
where the previous advanced state is a previous state of having advanced the secondary game before the selection device has selected at least one of the different number and the different type,
where the different number of the primary games is different from the number of the primary games that the selection device had selected, and the different type is different from the type of the primary games that the selection device had selected.

8. The game system according to claim 3,
wherein the game control device is configured to advance the secondary game using a previous advanced state information of the secondary game, in case that the selection device has selected at least one of a different number of the primary games and a different type of the primary games,
where the previous advanced state is a previous state of having advanced the secondary game before the selection device has selected at least one of the different number and the different type,
where the different number of the primary games is different from the number of the primary games that the selection device had selected, and the different type is different from the type of the primary games that the selection device had selected.

9. The game system according to claim 4,
wherein the game control device is configured to advance the secondary game using a previous advanced state information of the secondary game, in case that the selection device has selected at least one of a different number of the primary games and a different type of the primary games,
where the previous advanced state is a previous state of having advanced the secondary game before the selection device has selected at least one of the different number and the different type,
where the different number of the primary games is different from the number of the primary games that the selection device had selected, and the different type is different from the type of the primary games that the selection device had selected.

10. The game system according to claim 5,
wherein the game control device is configured to advance the secondary game using a previous advanced state information of the secondary game, in case that the selection device has selected at least one of a different number of the primary games and a different type of the primary games,
where the previous advanced state is a previous state of having advanced the secondary game before the selection device has selected at least one of the different number and the different type,
where the different number of the primary games is different from the number of the primary games that the selection device had selected, and the different type is different from the type of the primary games that the selection device had selected.

11. The game system according to claim 1,
wherein the game control device is configured to determine whether or not a previous advanced state of the secondary game reaches a predefined game state, and
wherein the game control device is configured to start or advance the secondary game, after the game control device determined that the previous advanced state of the secondary game reached the predefined game state, in case that the selection device has selected at least one of a different number of the primary games and a different type of the primary games,
where the previous advanced state being a previous state of having advanced the secondary game before the selection device has selected at least one of the different number and the different type, and
where the different number of the primary games is different from the number of the primary games that the selection device had selected, and the different type is different from the type of the primary games that the selection device had selected.

12. The game system according to claim 2,
wherein the game control device is configured to determine whether or not a previous advanced state of the secondary game reaches a predefined game state, and
wherein the game control device is configured to start or advance the secondary game, after the game control device determined that the previous advanced state of the secondary game reached the predefined game state, in case that the selection device has selected at least one of a different number of the primary games and a different type of the primary games,
where the previous advanced state being a previous state of having advanced the secondary game before the selection device has selected at least one of the different number and the different type, and
where the different number of the primary games is different from the number of the primary games that the selection device had selected, and the different type is different from the type of the primary games that the selection device had selected.

13. The game system according to claim 3,
wherein the game control device is configured to determine whether or not a previous advanced state of the secondary game reaches a predefined game state, and
wherein the game control device is configured to start or advance the secondary game, after the game control device determined that the previous advanced state of the secondary game reached the predefined game state, in case that the selection device has selected at least one of a different number of the primary games and a different type of the primary games,
where the previous advanced state being a previous state of having advanced the secondary game before the selection device has selected at least one of the different number and the different type, and
where the different number of the primary games is different from the number of the primary games that the selection device had selected, and the different type is different from the type of the primary games that the selection device had selected.

14. The game system according to claim 4,
wherein the game control device is configured to determine whether or not a previous advanced state of the secondary game reaches a predefined game state, and
wherein the game control device is configured to start or advance the secondary game, after the game control device determined that the previous advanced state of the secondary game reached the predefined game state, in case that the selection device has selected at least one of a different number of the primary games and a different type of the primary games,
where the previous advanced state being a previous state of having advanced the secondary game before the selection device has selected at least one of the different number and the different type, and
where the different number of the primary games is different from the number of the primary games that the selection device had selected, and the different type is different from the type of the primary games that the selection device had selected.

15. The game system according to claim 5,
wherein the game control device is configured to determine whether or not a previous advanced state of the secondary game reaches a predefined game state, and
wherein the game control device is configured to start or advance the secondary game, after the game control device determined that the previous advanced state of the secondary game reached the predefined game state, in case that the selection device has selected at least one of a different number of the primary games and a different type of the primary games,
where the previous advanced state being a previous state of having advanced the secondary game before the selection device has selected at least one of the different number and the different type, and
where the different number of the primary games is different from the number of the primary games that the selection device had selected, and the different type is different from the type of the primary games that the selection device had selected.

16. The game system according to claim 1,
wherein the game control device is configured to determine, in case that the selection device selected plural primary games, whether or not a currently advanced state of each of the plural primary games, selected by the selection device, belonging to the primary games, reaches a respectively predefined game state and the game control device is configured to determine whether or not the number of the plural primary games, which are each determined to have reached the respectively predefined game state, is equal to or more than a threshold,
wherein the game control device is configured to start or advance the secondary game, after the game control device determined that the number of the plural primary games is equal to or more than a threshold.

17. The game system according to claim 1,
wherein the game control device is configured to distribute reward of the secondary game to each of players that are playing the plural primary games selected by the selection device.

18. A game method comprising:
selecting, for selecting one or more base games, at least one of a) the number of one or more primary games; and b) a type of the one or more base games, using at least a predefined information; and
starting or advancing a secondary game, which is subordinate to the one or more primary games, based at least in part on a game state of the one or more base games selected.

19. A non-transitory computer readable medium that stores one or more computer programs, when executed by one or more computers, causing the one or more computers to perform a game method which comprising:
selecting, for selecting one or more base games, at least one of a) the number of one or more primary games; and b) a type of the one or more base games, using at least a predefined information; and
starting or advancing a secondary game, which is subordinate to the one or more primary games, based at least in part on a game state of the one or more base games selected.
